(19) United States
(12) Patent Application Publication
(10) Pub. No.: US 2009/0170546 A1
(43) Pub. Date: Jul. 2, 2009

(54) WIRELESS COMMUNICATION SYSTEM, COMMUNICATION TERMINAL AND COMPUTER-READABLE STORAGE MEDIUM STORING WIRELESS COMMUNICATION CONTROL PROGRAM

(75) Inventor: Makoto NISHIDA, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/402,917

(22) Filed: Mar. 12, 2009

Related U.S. Application Data
(63) Continuation-in-part of application No. PCT/JP2007/066523, filed on Aug. 27, 2007.

(30) Foreign Application Priority Data
Sep. 15, 2006 (JP) 2006-250224

(51) Int. Cl. H04B 7/00

(52) U.S. Cl. 455/517

(57) ABSTRACT

A wireless communication system comprised of a control terminal and controlled terminals which belong to one or a plurality of groups, the control information being transmitted in group units, the control terminal includes a transmission order determination device determining an order of transmission destination groups to which the control information is transmitted, and a control information transmission device transmitting the control information in the order determined by the transmission order determination device, and the controlled terminals each includes a control information receiving device receiving the control information, a communication information storage device storing communication information, a transition determination device determining whether the controlled terminal becomes a next control terminal that is a control terminal next to a current control terminal, and a next control terminal transition device transferring the controlled terminal itself to become the next control terminal according to the determination by the transition determination device.

### CROSS-REFERENCE TO RELATED APPLICATION

This application is a U.S. continuation-in-part application filed under 35 USC 111(a) claiming benefit under 35 USC 120 and 365(c) of International Application No. PCT/JP2007/066523 filed Aug. 2, 2007, which claims priority to Application Ser. No. 2006-250224, filed in Japan on Sep. 15, 2006. The disclosure of the foregoing applications is hereby incorporated by reference in their entireties.

### BACKGROUND

The present disclosure relates to a wireless communication system, a communication terminal, and a wireless communication program.

Generally, in wireless ad hoc communication that is not performed via an access point, when one terminal is communicating with a plurality of terminals, it is conceivable that communication may become impossible for some reason. For example, if a terminal performing broadcasting (hereinafter referred to as the “control terminal”) malfunctions, it is desirable to replace it with another terminal. A method is disclosed, for example, in Japanese Laid-Open Patent Publication No. 2005-6327, in which an order of priority for terminals that can become control terminals (coordinator terminals) and perform broadcasting is determined in advance. Then, if a problem occurs in communication using the current coordinator terminal, it is promptly replaced by another terminal.

However, when a plurality of terminals belong to a plurality of groups and communication is synchronously performed in group units, only the control terminal that malfunctioned knows which group it was communicating with when the communication failed. Therefore, even if another terminal is selected as a control terminal in accordance with the order of priority determined in advance as in the related art, it is unclear from which group communication is to be restarted. As a result, it is difficult to continue synchronous communication.

### SUMMARY

The present disclosure addresses the problems described above and provides a wireless communication system, a communication terminal, and a computer-readable storage medium storing wireless communication control program that enable a new control terminal to identify a group from which communication is to be started when a control terminal malfunctions when wireless communication is synchronously performed in group units.

According to a first aspect of this disclosure, there is provided a wireless communication system in which a control terminal that transmits control information and a plurality of controlled terminals that operate based on the control information transmitted from the control terminal are connected via a wireless communication network, and the control terminal and the controlled terminals belong to one or a plurality of groups, the control information being transmitted in group units, wherein the control terminal includes a transmission order determination device that determines an order of transmission destination groups to which the control information is transmitted, and a control information transmission device that transmits the control information to the controlled terminals in the order determined by the transmission order determination device, and wherein the controlled terminals each includes a control information receiving device that receives the control information from the control terminal, a communication information storage device that stores communication information that is information relating to the communication when the control information receiving device receives the control information, a transition determination device that determines whether the controlled terminal becomes a next control terminal that is a control terminal next to a current control terminal, and a next control terminal transition device that transfers the controlled terminal itself to become the next control terminal when the transition determination device determines that the controlled terminal becomes the next control terminal and wherein when the controlled terminal is transferred to become the next control terminal by the next control terminal transition device, the transmission order determination device of the control terminal identifies, from among the groups, a next transmission group to which the control information is to be transmitted next, based on the communication information stored in the communication information storage device of each of the controlled terminals.

According to a second aspect of this disclosure, there is provided a communication terminal that is mutually connected to other communication terminals via a wireless communication network where the communication terminals belong to one or a plurality of groups, the communication terminal functioning either as a control terminal that transmits control information to each of the groups or as a controlled terminal that operates based on the control information transmitted from the control terminal, wherein when the communication terminal functions as the control terminal, the communication terminal includes a transmission order determination device that determines an order of transmission destination groups to which the control information is transmitted and a control information transmission device that transmits the control information to the controlled terminal in the order determined by the transmission order determination device, and when the communication terminal functions as the controlled terminal, the communication terminal includes a control information receiving device that receives the control information from the control terminal a communication information storage device that stores communication information that is information relating to the communication when the control information receiving device receives the control information a transition determination device that determines whether the communication terminal becomes a next control terminal that is a control terminal next to a current control terminal and a next control terminal transition device that transfers the communication terminal itself to become the next control terminal when the transition determination device determines that the communication terminal becomes the next control terminal, and wherein when the communication terminal is transferred from being the controlled terminal to becoming the next control terminal by the next control terminal transition device and functions as the control terminal, the transmission order determination device identifies, from among the groups, a next transmission group to which the control information is to be transmitted next, based on the communication information stored in the communication information storage device of each of the controlled terminals.

According to a third aspect of this disclosure, there is provided a computer-readable storage medium storing wireless communication control program that command a computer to function as various processing devices of the communication terminal that is mutually connected to other communication terminals via a wireless communication network where the communication terminals belong to one or a plurality of groups, the communication terminal functioning either as a control terminal that transmits control information to each of the groups or as a controlled terminal that operates based on the control information transmitted from the control terminal, wherein when the communication terminal functions as the control terminal, the program including a transmission order determination step that determines an order of transmission destination groups to which the control information is transmitted, and a control information transmission step that transmits the control information to the controlled terminal in the order determined at the transmission order determination step, and when the communication terminal functions as the controlled terminal, the program including a control information receiving step that receives the control information from the control terminal, a communication information storage step that stores communication information that is information relating to the communication when the control information is received at the control information receiving step, a transition determination step that determines whether the communication terminal becomes a next control terminal that is a control terminal next to a current control terminal, and a next control terminal transition step that transfers the communication terminal itself to become the next control terminal when it is determined that the communication terminal becomes the next control terminal at the transition determination step, and wherein when the communication terminal is transferred from being the controlled terminal to becoming the next control terminal at the next control terminal transition step and functions as the control terminal, the transmission order determination step identifies, from among the groups, a next transmission group to which the control information is to be transmitted next, based on the communication information stored at the communication information storage step.

Other objects, features, and advantages of the present disclosure will be apparent to persons of ordinary skill in the art in view of the following detailed description of embodiments of the invention and the accompanying drawings.

### BRIEF DESCRIPTION OF THE DRAWINGS

FIG. 1 is an explanatory diagram showing an outline of a wireless communication system according to a first embodiment;

FIG. 2 is a block diagram showing an electrical configuration of a leader terminal and a member terminal;

FIG. 3 is a schematic diagram showing storage areas in a RAM;

FIG. 4 is a schematic diagram showing a leader selection priority order table stored in a priority order storage area;

FIG. 5 is a schematic diagram showing a terminal information table stored in a terminal information storage area;

FIG. 6 is an explanatory diagram showing data transmitted and received using a wireless communication system;

FIG. 7 is a flowchart of a main process of a communication terminal;

FIG. 8 is a flowchart of a leader terminal process that is performed in the main process;

FIG. 9 is a flowchart of a member terminal process that is performed in the main process;

FIG. 10 is a flowchart of a new leader terminal process that is performed in the main process;

FIG. 11 is a flowchart of a control information reception time collection process that is performed in the new leader terminal process;

FIG. 12 is a flowchart of a communication restart group identification process that is performed in the new leader terminal process;

FIG. 13 is an explanatory diagram showing an example of a terminal information table that registers control information reception times collected by a new leader terminal;

FIG. 14 is an explanatory diagram showing data transmitted and received using the wireless communication system according to a second embodiment;

FIG. 15 is an explanatory diagram showing an example of the terminal information table according to the second embodiment;

FIG. 16 is a flowchart of a leader terminal process according to the second embodiment that is performed in the main process;

FIG. 17 is a flowchart of a member terminal process according to the second embodiment that is performed in the main process;

FIG. 18 is a flowchart of a new leader terminal process according to the second embodiment that is performed in the main process;

FIG. 19 is a flowchart of a control information number collection process that is performed in the new leader terminal process;

FIG. 20 is a flowchart of a communication restart group identification process that is performed in the new leader terminal process;

FIG. 21 is an explanatory diagram showing an outline of the wireless communication system according to a third embodiment;

FIG. 22 is an explanatory diagram showing data transmitted and received using the wireless communication system according to the third embodiment;

FIG. 23 is an explanatory diagram showing an example of a group terminal information table stored in the RAM.

FIG. 24 is an explanatory diagram showing an example of a terminal information table that registers results collected from respective group leader terminals;

FIG. 25 is a flowchart of a main process of a communication terminal according to the third embodiment;

FIG. 26 is a flowchart of a member terminal process that is performed in the main process;

FIG. 27 is a flowchart of a group leader terminal process that is performed in the main process;

FIG. 28 is a flowchart of an own group terminal control information reception time collection process that is performed in the group leader terminal process;

FIG. 29 is a flowchart of a control information reception time collection process that is performed in a new leader terminal process according to the third embodiment;

FIG. 30 is an explanatory diagram showing data transmitted and received using the wireless communication system according to a fourth embodiment;

FIG. 31 is a flowchart of a group leader terminal process according to the fourth embodiment;

FIG. 32 is a flowchart of an own group terminal control information reception time collection process that is performed in the group leader terminal process;

FIG. 33 is a flowchart of a control information reception time collection process that is performed in the new leader terminal process; and

FIG. 34 is a flowchart of a communication restart group identification process that is performed in the new leader terminal process.

### DETAILED DESCRIPTION

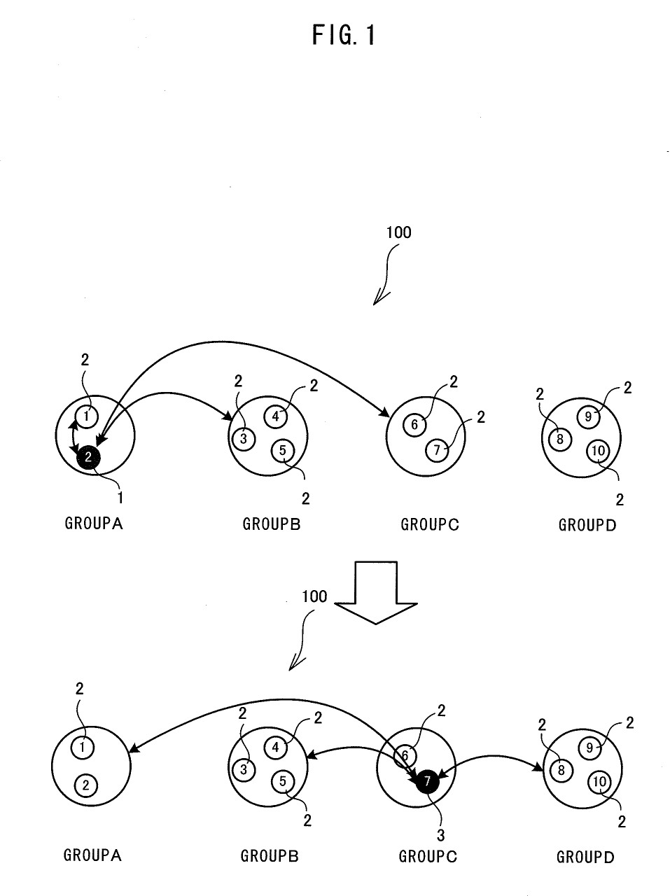

Hereinafter, four embodiments will be described in order from a first embodiment to a fourth embodiment. First, a wireless communication system 100 according to the first embodiment will be described with reference to the figures. First, an outline of the wireless communication system 100 according to the first embodiment will be described with reference to FIG. 1.

In the wireless communication system 100 shown in the upper section of FIG. 1, a plurality of wireless communication terminals are performing ad hoc communication. Each of the wireless communication terminals has the same physical structure (to be explained in detail later), and each of the wireless communication terminals functions either as a control terminal (hereinafter referred to as the “leader terminal”) that transmits control information to the other terminals, or as a controlled terminal (hereinafter referred to as the “member terminal”) that receives the control information and performs prescribed operations in accordance with the control information. In the wireless communication system 100, a plurality of groups (four groups, i.e., group A, group B, group C and group D in FIG. 1) are present, and a leader terminal 1 and member terminals 2 belong to one of the groups. The leader terminal 1 performs synchronous communication in group units.

When the leader terminal 1 becomes unable to communicate (out of the communication range, a shield, failure, etc.), a new leader terminal 3 is selected from among the member terminals 2 in accordance with an order of priority determined in advance. As shown in the lower section of FIG. 1, the new leader terminal 3 collects the latest reception time at which each of the member terminals 2 received the control information from the previous leader terminal 1, and identifies the group with which communication is to be restarted based on the collected data.

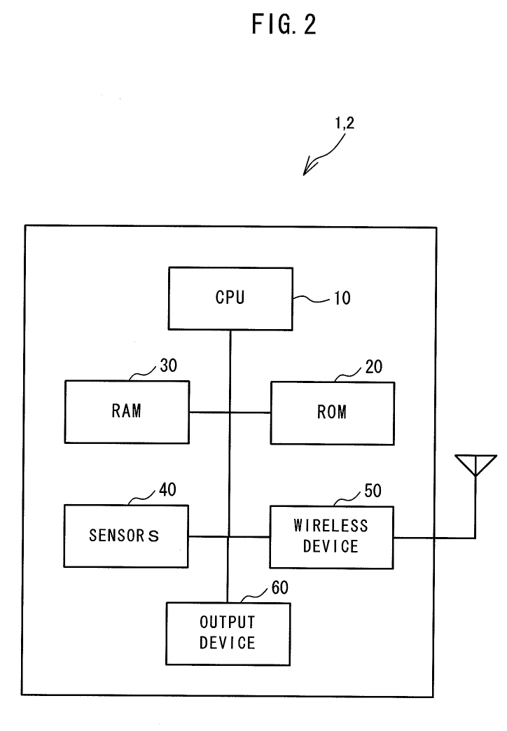

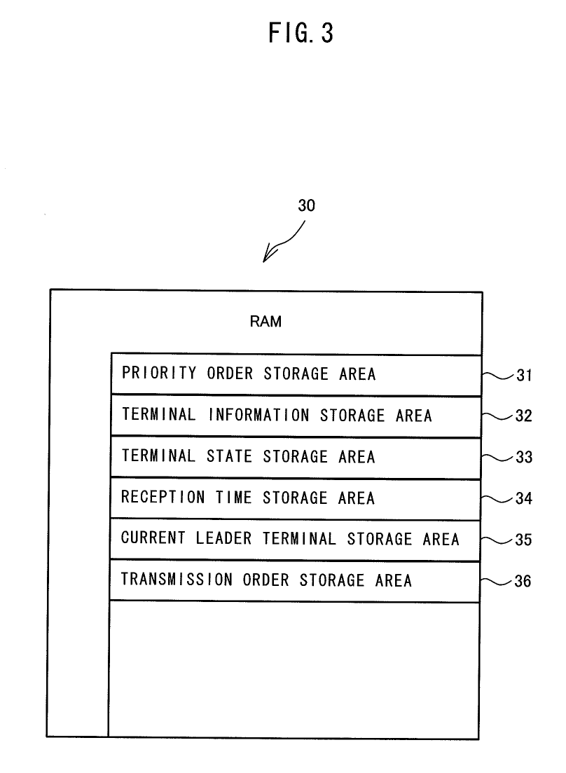

Next, an electrical configuration of the communication terminals (the leader terminal 1 and the member terminal 2) that form the wireless communication system 100 will be described with reference to FIG. 2 and FIG. 3.

As shown in FIG. 2, the leader terminal 1 and the member terminal 2 include a CPU 10 that controls the overall functions of the communication terminal, a ROM 20 that stores programs etc. and a RAM 30 that temporarily stores data. The ROM 20 and the RAM 30 are connected via a bus to the CPU 10. The leader terminal 1 and the member terminal 2 include a variety of sensors 40 and an output device 60. A temperature sensor, an infrared sensor, a light sensor, a microphone and the like are used, for example, in the sensors 40. An LED, a motor, speakers and the like are used, for example, in the output device 60. The leader terminal 1 and the member terminal 2 include a wireless device 50 for communication with other terminals.

Further, as shown in FIG. 3, the RAM 30 is provided with at least a priority order storage area 31, a terminal information storage area 32, a terminal state storage area 33, a reception time storage area 34, a current leader terminal storage area 35, and a transmission order storage area 36. The priority order storage area 31 stores a leader selection priority order table that is used to select the next leader terminal 1 when the leader terminal 1 fails. The terminal information storage area 32 stores, as a terminal information table, information collected from each of the terminals when the new leader terminal 3 is selected. The terminal state storage area 33 stores information indicating whether the current state of the terminal itself is the leader terminal 1. The reception time storage area 34 stores the time at which the control information is received. The current leader terminal storage area 35 stores the terminal ID of the current leader terminal 1. The transmission order storage area 36 stores the order of the groups to which the control information is transmitted.

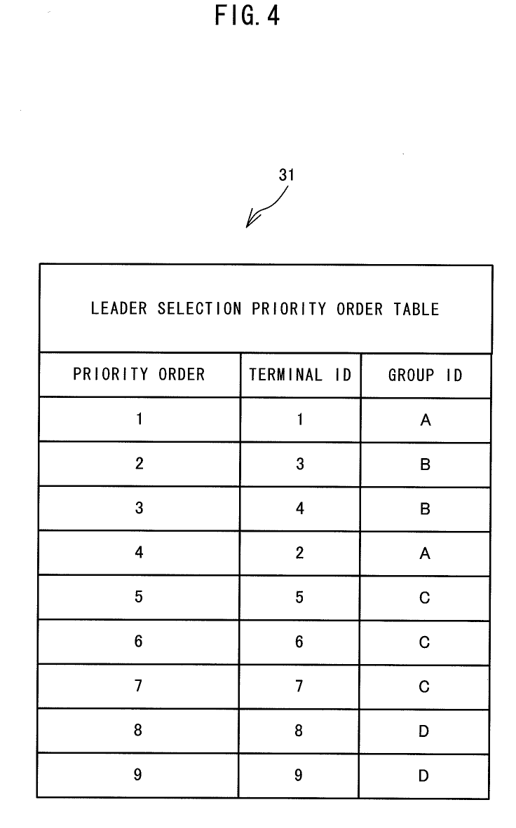

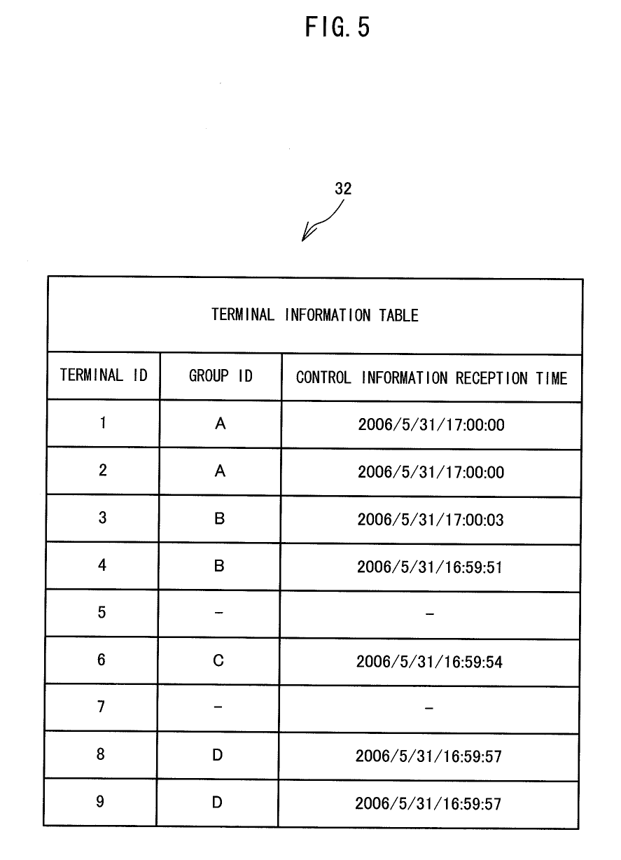

Next, the leader selection priority order table and the terminal information table stored in the RAM 30 will be described with reference to FIG. 4 and FIG. 5.

As shown in FIG. 4, in the leader selection priority order table stored in the priority order storage area 31, respective items, i.e., the priority order, the terminal ID and the group ID are stored for each of the terminals, and these items are arranged in the priority order. When transmission of the control information from the current leader terminal 1 is interrupted, each of the member terminals 2 refers to the current leader terminal storage area 35 and the leader selection priority order table. If the terminal itself has the terminal ID that is next, in the priority order, to the terminal ID stored in the current leader terminal storage area 35, that terminal is determined as the new leader terminal 3.

As shown in FIG. 5, in the terminal information table of the terminal information storage area 32, the terminal ID, the group ID, and the control information reception time are stored for each of the terminals. When the new leader terminal 3 is selected, it collects the latest control information reception time from each of the member terminals, and sequentially stores the latest control information reception time in this table, When the leader terminal 1 is replaced, the data of the terminal is deleted from this table.

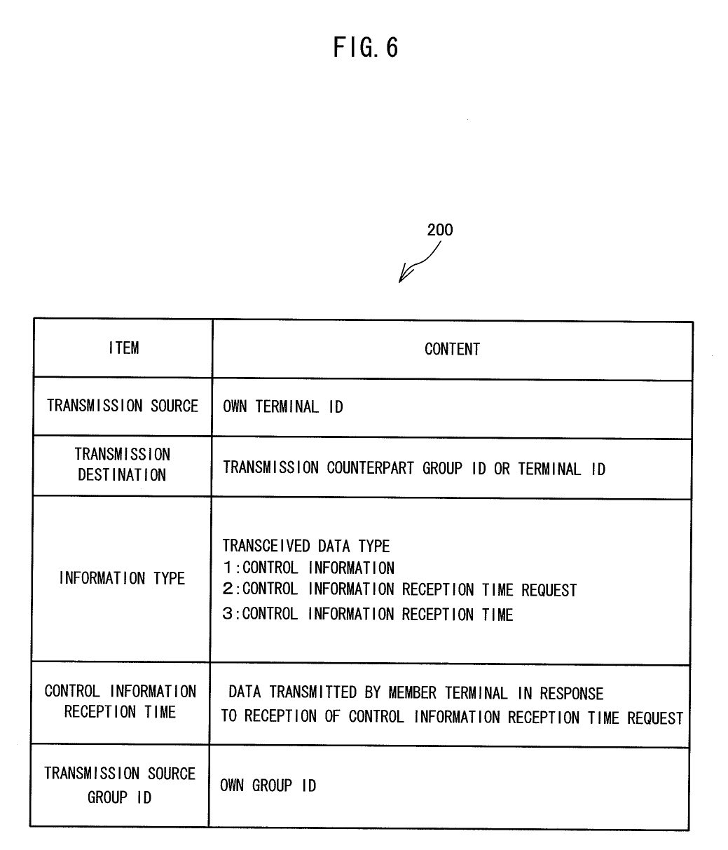

Next, the operations of the wireless communication system 100 having the above configuration will be described with reference to FIG. 6 to FIG. 13.

The data shown in FIG. 6 is transmitted and received in the wireless communication system 100 of the first embodiment. As shown in FIG. 6, transceived data 200 includes five items, i.e., transmission source information, transmission destination information, information type, control information reception time, and transmission source group ID. The ID of the terminal (own terminal ID) that transmits the data is set in the transmission source information. The ID of the group (own group ID) to which the terminal that transmits the data belongs is set in the transmission source group ID. The group ID or the terminal ID of the transmission counterpart is set in the transmission destination information. As broadcast communication is performed in the wireless communication system 10, the transmission counterpart ID is essential. When the transmission destination information of the received data matches the own terminal ID or the ID of the group to which the terminal belongs, the terminal determines that the data is targeted to itself. One of the values from 1 to 3 is set in the information type. More specifically, the values are assigned as follows: 1: control information (leader terminal 1→member terminal 2), 2: control information reception time request (new leader terminal 3→member terminal 2), and 3: control information reception time (member terminal 2→new leader terminal 3). When the information type is 3, data for the control information reception time is set and transmitted.

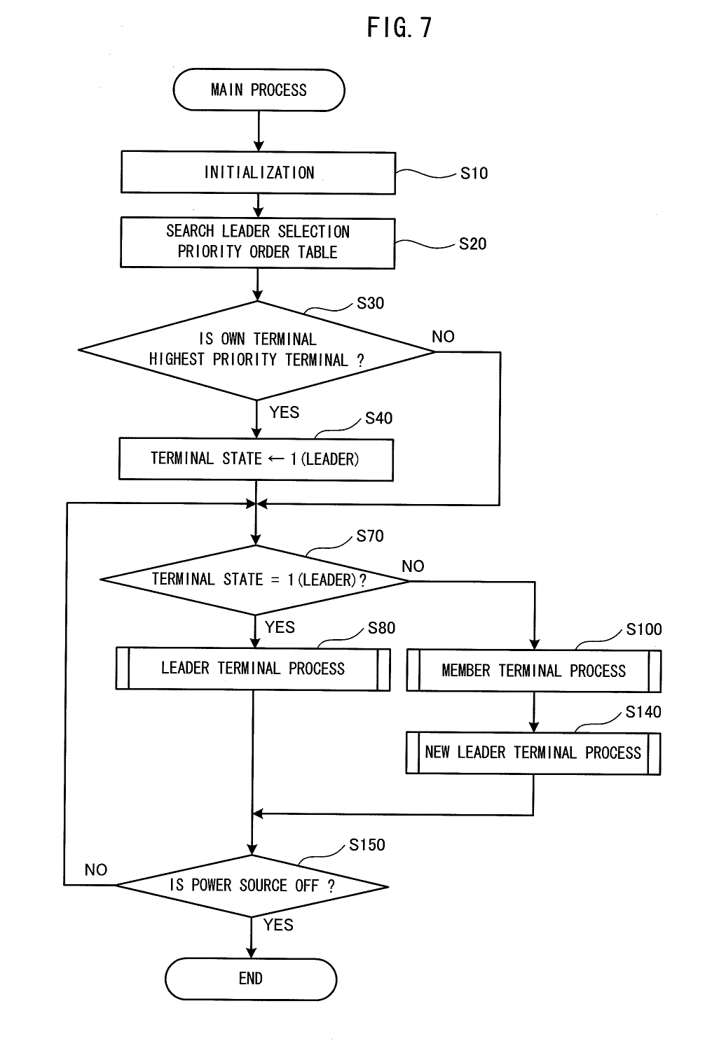

In the first embodiment, each of the communication terminals repeatedly performs a main process, as shown in FIG. 7, from the point at which the power source is turned on until the power source is turned off. During the main process, if the communication terminal is the current leader terminal 1, it performs processing as the leader terminal 1. On the other hand, if the communication terminal is the member terminal 2, it performs processing as the member terminal 2. Further, during the processing as the member terminal, if the control information is not transmitted from the leader terminal 1 after a certain period of time has elapsed, and if the terminal itself is highest in the priority order, processing as the new leader terminal 3 is performed.

As shown in FIG. 7, when the power source is turned on, first, an initialization process is performed (step S10) In the initialization process, for example, the storage area of the RAM 30 is cleared. Then, the leader selection priority order table stored in the priority order storage area 31 is searched (step S20). As a result of the search, if the terminal itself is the highest priority terminal (yes at step S30), it stores “1” in the terminal state storage area 33 in order to perform the processing as the leader terminal 1. Here, “terminal state=1” indicates that the terminal is the leader terminal 1. If the terminal is not the highest priority terminal (no at step S30), the process proceeds directly to step S70. For example, in the case of the leader selection priority order table shown in FIG. 4, the communication terminal whose terminal ID is “1” satisfies “terminal state=1”, and the other terminals directly proceed to step S70.

Next, it is determined whether the terminal state is “1” (the leader terminal 1) by referring to the terminal state storage area 33. In the case of the leader terminal 1 (yes at step S70), a leader terminal process is performed (step S80). When the terminal state is not “1” (no at step S70), a member terminal process is performed (step S100). Further, in a particular case, a new leader terminal process is performed (step S140).

When the leader terminal process or the new leader terminal process is completed, it is determined whether the power source is turned off (step S150). When the power source is turned off (yes at step S150), all the processes are ended. When the power source is not turned off (no at step S150), the process returns to step S70 to repeat the process.

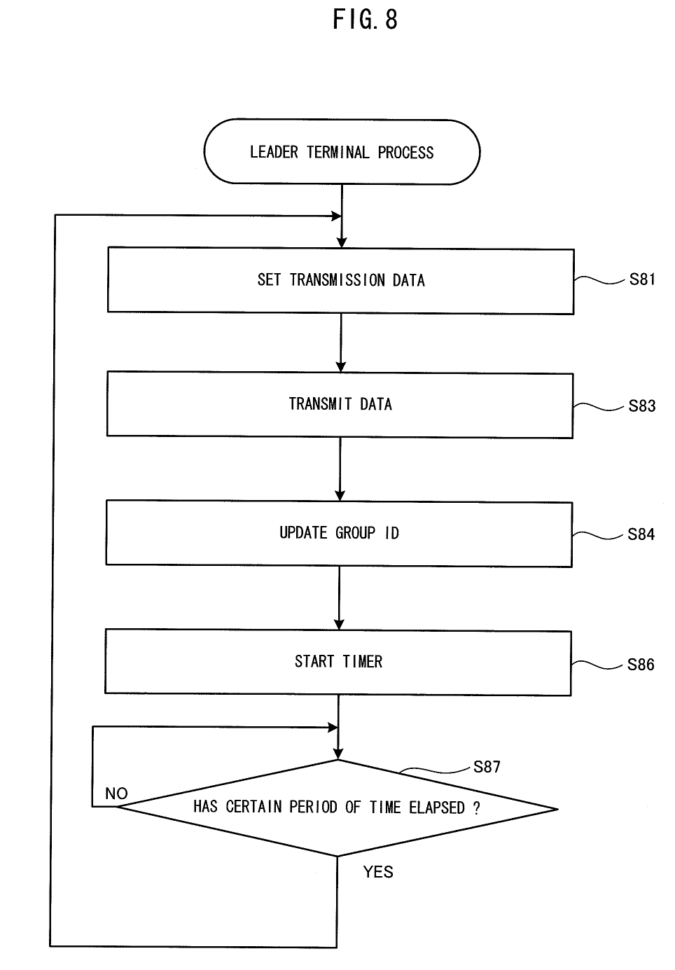

Next, the leader terminal process will be described with reference to FIG. 8. The leader terminal process is performed in the main process shown in FIG. 7 when the terminal state is “1” (yes at step S70).

As shown in FIG. 8, when the leader terminal process is started, first, transmission data setting for transmitting the control information to the member terminals 2 is performed (step S81). As described above, in the present embodiment, the transceived data is structured as shown in FIG. 6. Therefore, the own terminal ID is set in the transmission source, the own group ID is set in the transmission source group ID, the ID of a group (a current communication group) with which the leader terminal 1 is to perform communication from now is set in the transmission destination, and “1” is set in the information type. The communication group is set in accordance with the transmission order stored in the transmission order storage area 36. Note that the information type “1” is the control information that causes each of the member terminals to perform a certain process. The content (control content) of the process caused to be performed by each of the member terminals may be determined in advance, or the control content may be transmitted in a command format with the transmission data. Examples of the process are, for example, illumination of an LED on the terminal, driving a motor, output of audio and the like.

When the transmission data setting is completed, the data is actually transmitted (step S83), and the current communication group ID is updated with the next group ID in the transmission order, in accordance with the transmission order stored in the transmission order storage area 36 (step S84). Then, a timer is started (step S86). After a certain period of time has elapsed (step S87), the process returns to step S81, and communication with the next group is performed. The above processing is repeatedly performed in the leader terminal process.

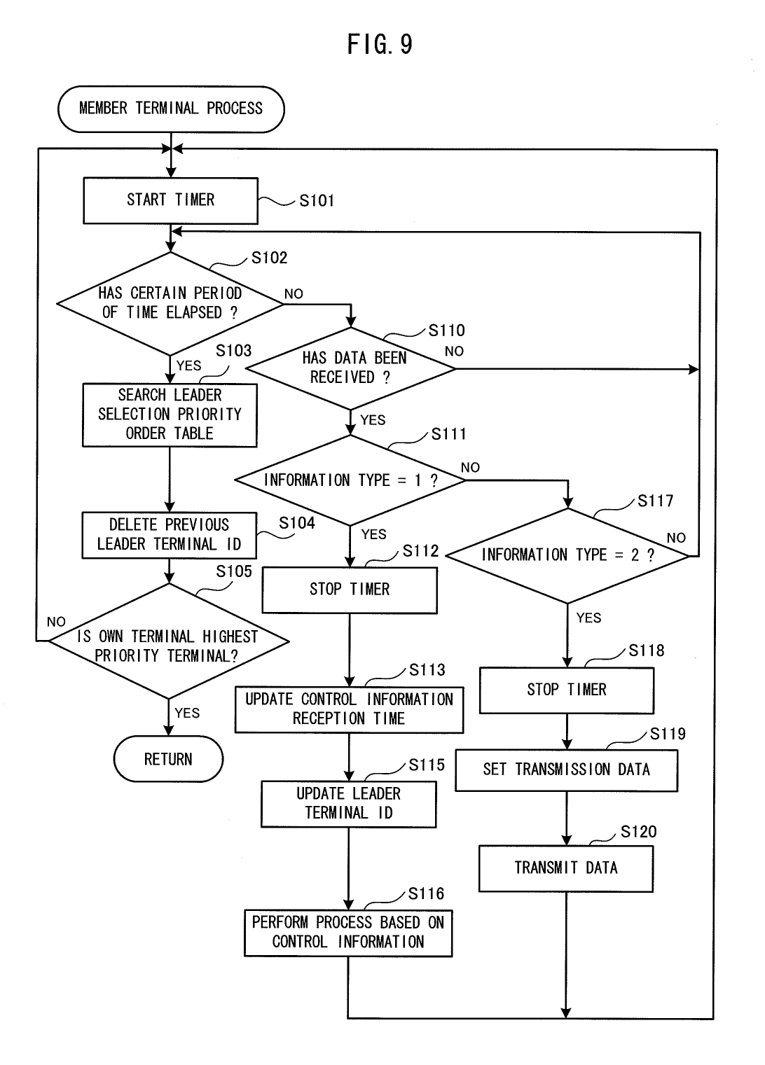

Next, the member terminal process will be described with reference to FIG. 9. The member terminal process is performed when the terminal state is not “1” (no at step S70) in the main process shown in FIG. 7. In the member terminal process, when data is received from the leader terminal 1, processing in accordance with the information type of the received data is performed. In addition, time is measured using a timer. When no data is transmitted from the leader terminal 1 after a certain period of time has elapsed, it is determined that a failure has occurred in communication with the leader terminal 1. Then, it is determined whether the terminal itself should become the new leader terminal 3 in accordance with the leader selection priority order table in the priority order storage area 31.

When the member terminal process is started, first, the timer is started in order to measure the time required to receive the control information from the leader terminal 1 (step S101). Next, it is determined whether a certain period of time has elapsed (step S102). When the certain period of time has elapsed (yes at step S102), there is a failure in communication with the leader terminal 1. Therefore, then, the leader selection priority order table stored in the priority order storage area 31 is searched (step S103). Then, information corresponding to the terminal ID of the previous leader terminal 1, which is stored in the current leader terminal storage area 35, is deleted from the terminal information table (refer to FIG. 5) stored in the terminal information storage area 32 (step S104). For example, if the previous leader terminal 1 is the communication terminal whose terminal ID is “2”, the record of the terminal ID “2” is deleted.

Next, it is determined, based on the search result at step S103, whether the terminal itself is the highest priority terminal (step S105). This can be determined based on whether the own terminal ID is the terminal ID that is next, in the priority order, to the terminal ID of the leader terminal 1 stored in the current leader terminal storage area 35. When the terminal itself is the highest priority terminal (yes at step S105), the process returns to the main process once in order to perform the processing as the new leader terminal 3. When the terminal itself is not the highest priority terminal (no at step S105), the process returns to step S101 in order to wait for another priority terminal to complete the processing as the new leader terminal 3, and the timer is started again.

When the certain period of time has not elapsed at step S102 (no at step S102), it is determined whether data has been received (step S110). When data has not been received (no at step S110), the process returns to step S102 and it is determined whether the certain period of time has elapsed. When data has been received (yes at step S110), it is determined whether the received information type is “1” (step S111). When the received information type is “1” (yes at step S111), the data is the control information from the leader terminal 1. Therefore, the timer is stopped (step S112), and the control information reception time is updated and stored in the reception time storage area 34 (step S113). Then, the current leader terminal ID is extracted from the transmission source information of the received data, and stored in the current leader terminal storage area 35 (step S115). Then, the process specified by the control information is performed (step S116), and the process returns to step S101 where the timer is started again.

When the information type of the received data is not “1” (no at step S111), next, it is determined whether the information type is “2” (step S117). When the information type is “2” (yes at step S117), the data is a request from the new leader terminal 3 for transmission of the control information reception time. Therefore, the timer is stopped (step S118), and the transmission data is set (step S119). More specifically, the own terminal ID is set in the transmission source, the transmission source terminal ID (the terminal ID of the new leader terminal 3) of the received data is set in the transmission destination, and the information type is set to “3”. The information type “3” indicates transmission of the control information reception time. Then, the reception time stored in the reception time storage area 34 is extracted and set. In addition, the own group ID is set as the transmission source group ID. Next, the set data is transmitted (step S120), and the process returns to step S101 where the timer is started again.

As described above, the member terminal process is repeatedly performed as long as data is transmitted from the leader terminal 1. Only when transmission from the leader terminal 1 is interrupted and the terminal itself becomes the new leader terminal 3 does the process return to the main process.

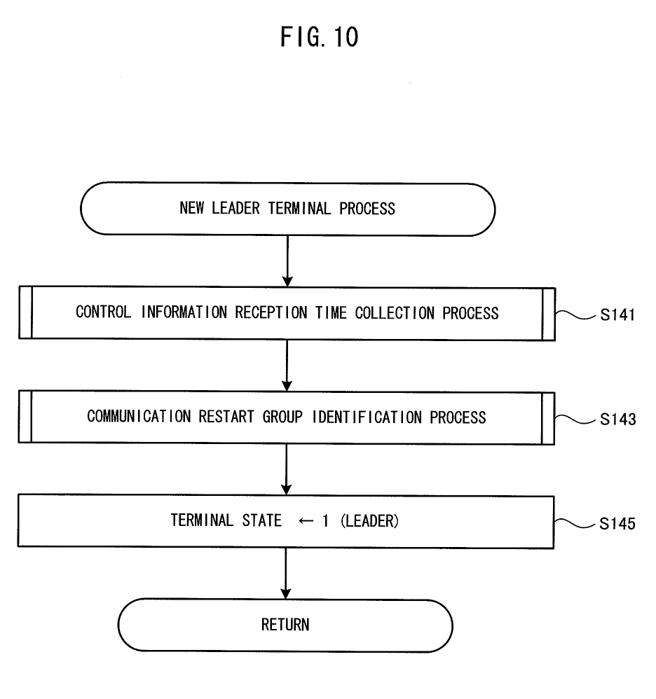

Next, the new leader terminal process will be described with reference to FIG. 10 to FIG. 12. The new leader terminal process is performed when, in the member terminal process (refer to FIG. 9), no data is transmitted from the leader terminal 1 after a certain period of time has elapsed (yes at step 3102 of FIG. 9), and further, the terminal itself is set as the highest priority terminal by the leader selection priority order table (yes at step S105 of FIG. 9).

As shown in FIG. 10, when the new leader terminal process is started, first, in order to collect the control information reception time from each of the member terminals 2, a control information reception time collection process is performed (step S141). In this process, a reception time transmission request is transmitted to each group, and the latest control information reception time is received from each of the member terminals 2. Then, a communication restart group identification process is performed that identifies, based on the collected reception times, the group with which communication is to be restarted (step S143). Then, the terminal state is set to “1” (step S145), and the process returns to the main process. As a result, in the next processing cycle, the “terminal state=1” and therefore, the terminal itself becomes the leader terminal 1 (yes at step S70 of FIG. 7). Therefore, the leader terminal process is performed.

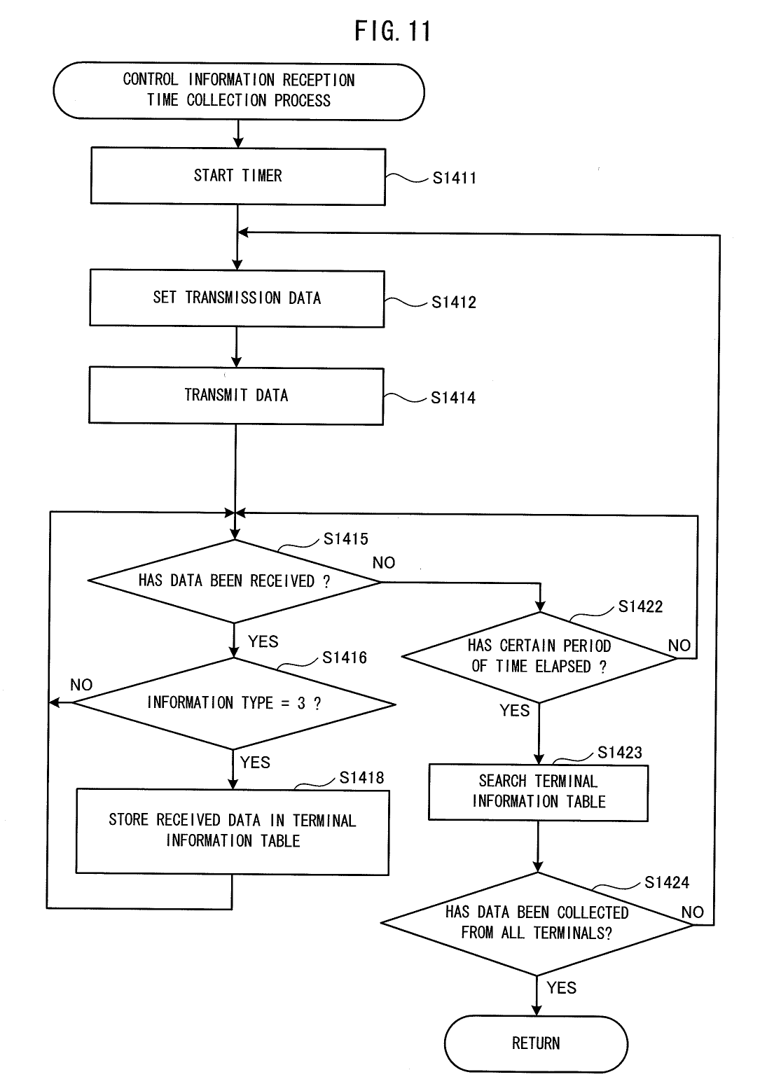

Here, details of the control information reception time collection process will be described with reference to FIG. 11. As shown in FIG. 11, when the control information reception time collection process is started, first, the timer is started (step S1411). Then, the transmission data for requesting each of the member terminals to transmit the reception time is set (step S1412). More specifically, the own terminal ID is set in the transmission source, the ID of the terminal whose reception time has not been registered in the terminal information table of the terminal information storage area 32 is set in the transmission destination, and the information type is set to “2”. The information type “2” indicates the request for the control information reception time.

Next, the set data is transmitted (step S1414), and it is determined whether data has been received (step S1415) When data has been received (yes at step S1415), it is determined whether the information type of the received data is “3,” (step S1416). As described earlier, the information type “3” is the data of the control information reception time that the member terminal 2 transmits in response to transmission of the data of the information type “2” (refer to step S119 of FIG. 9). When the information type is “3” (yes at step S1416), the terminal ID, the group ID, and the control information reception time are extracted from the received data, and registered in the terminal information table and stored in the terminal information storage area 32 (step S1418).

When data has not been received (no at step S1415), it is determined whether a certain period of time has elapsed from the start of the timer at step 31411 (step S1422). When the certain period of time has not elapsed (no at step S1422), the process returns to step S1415 to wait for data reception.

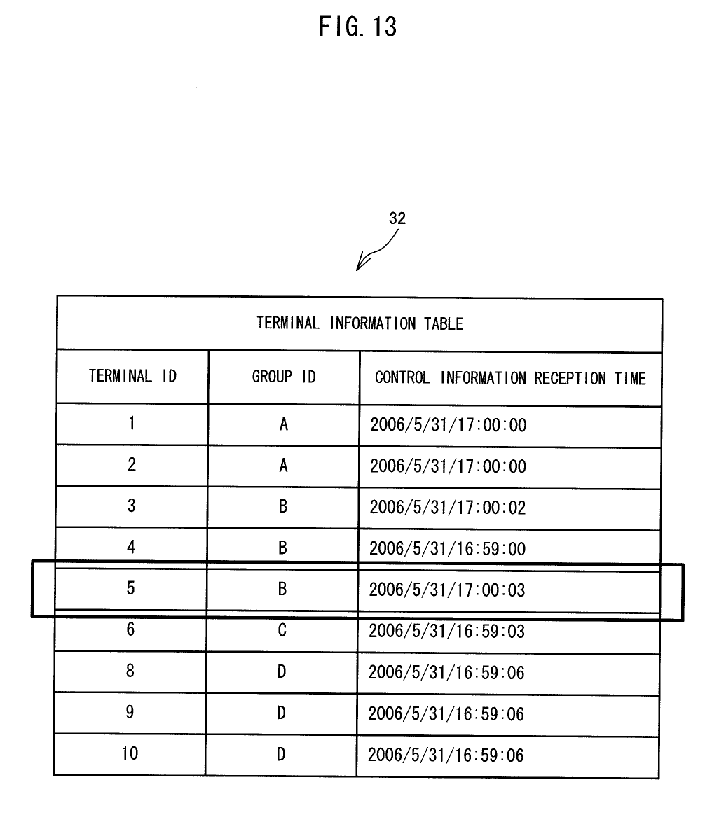

When the certain period of time has elapsed (yes at step S1422), the terminal information table is searched (step S1423), and it is determined whether data has been obtained from all the terminals (step S1424). When data from all the terminals has been collected (yes at step S1424), the process returns to the new leader terminal process. When data from all the terminals has not yet been collected (no at step S1424), the process returns to step S1412. Then, the terminal information table is searched, and the control information reception time request is made for the terminal ID whose control information reception time is not yet registered. Due to the above-described control information reception time collection process, the latest reception time data of all the terminals that are currently communicable in the wireless communication system 100 are registered in the terminal information table in the terminal information storage area 32. FIG. 13 shows a state of the terminal information table when the control information reception time collection process is completed. The terminal with the terminal ID “7” is the previous leader terminal, which was deleted from the terminal information table at the point in time point at which the control information was no longer transmitted even after the elapse of the certain period of time (refer to step S104 of FIG. 9).

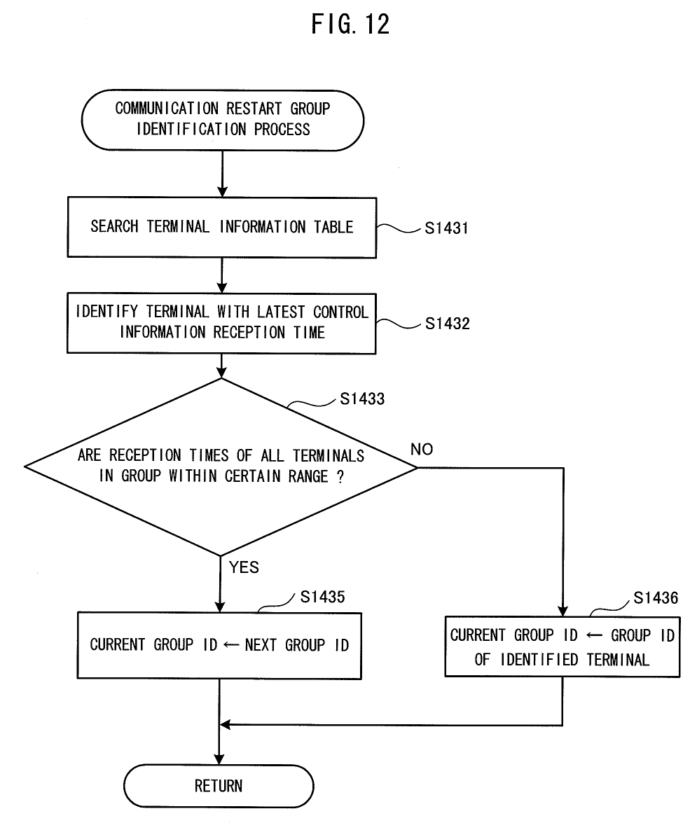

Next, details of the communication restart group identification process will be described with reference to FIG. 12 and FIG. 13. The communication restart group identification process determines to which group the new leader terminal 3 should next transmit the control information, based on the reception times in the respective terminals collected by the control information reception time collection process.

As shown in FIG. 12, when the communication restart group identification process is started, first, the terminal information table (refer to FIG. 13) in the terminal information storage area 32 is searched (step S1431). Next, the terminal that has the latest control information reception time in the terminal information table is identified (step S1432). For example, when the terminal information table is in the state shown in FIG. 13, the terminal that has the latest control information reception time is identified as the terminal with the terminal ID “5,” whose reception time is “2006/5/31/17:00:03”.

Next, it is determined whether the control information reception times of all the terminals that belong to the same group (group B to which the terminal 5 belongs, in the example shown in FIG. 13) as that of the terminal identified at step S1432 are within a certain range (step S1433). Normally, the terminals in the same group have approximately the same reception time. Therefore, if the reception times of the terminals in the same group are within the certain range (yes at step S1433), reception has been completed normally in that group. Thus, the group that is next to the group of the terminal identified at step S1432 is identified as the group to be communicated with (step S1435). For example, if the communication order of the groups is set as A, B, C, D . . . , and if the group of the identified terminal is B, the ID of the group (the current group) to be communicated with is determined as being “C”. Then, the process returns to the new leader terminal process. The group identified here is the group to which the control information will be transmitted when the process returns to the main process (refer to FIG. 7) and the leader terminal process is performed (refer to step S81 of FIG. 8).

When the reception times of the terminals in the same group are not within the certain range (no at step S1433), it is conceivable that a failure has occurred during communication with the group. Therefore, it is determined that communication is to be first performed with that group (step S1436). For example, in the case of FIG. 13, the terminals of the group B to which the terminal 5 belongs are the terminal 3, terminal 4, and terminal 5. However, the reception time of the terminal 3 is “2006/5/31/17:00:02”, the reception time of the terminal 4 is “2006/5/31/16:59:00”, and the reception time of the terminal 5 is “2006/5/31/17:00:03”. The terminal 3 and the terminal 5 have approximately the same reception time, but the reception time of the terminal 4 is about one minute earlier. In this case, there is a high probability that the control information of the same content as that of the terminal 3 and the terminal 5 has not been transmitted to the terminal 4. Therefore, the current group ID is set to “B” in order to restart communication from the group B. Then, the process returns to the new leader terminal process. The group identified here is the group to which the control information will be transmitted when the process returns to the main process (refer to FIG. 7) and the leader terminal process is performed (refer to step S81 of FIG. 8).

As described above, in the wireless communication system 100 of the first embodiment, each of the communication terminals stores the IDs of all the terminals in the terminal information table. Further, the priority order of the terminals that should function as the leader terminal 1 is stored as the leader selection priority order table. Moreover, whether the terminal itself is currently the leader terminal 1 or the member terminal 2 is identified based on the terminal state. When the terminal state is “1”, the processing as the leader terminal 1 is performed, and when the terminal state is not “1”, the processing as the member terminal 2 is performed. In the processing as the leader terminal 1, the control information is transmitted to each group so as to cause each of the member terminals 2 to perform a certain process. In the processing as the member terminal 2, the process in accordance with the control information received from the leader terminal 1 is performed. In addition, the reception time at which each of the member terminals 2 receives the control information is stored. If data transmitted from the leader terminal 1 cannot be received within a certain period of time, it is determined whether the terminal itself becomes the new leader terminal 3 by referring to the stored leader selection priority order table. When the own terminal becomes the new leader terminal 3, it requests the other terminals to send the control information reception time, and stores the obtained reception times of the respective member terminals 2 in the terminal information table. Then, the new leader terminal 3 identifies, as the communication restart group, the group including the terminal having the latest reception time, or the group next to that group. When the terminal itself does not become the new leader terminal 3, it transmits the control information reception time in response to the request from the new leader terminal 3. Therefore, even when communication from the leader terminal 1 is interrupted by, for example, presence of an obstruction, movement of the leader terminal 1, or failure of the leader terminal 1, one of the member terminals 2 can function as the new leader terminal in accordance with the priority order. Moreover, the control information reception times are collected and used to determine up to which group transmission of the control information was completed when the communication was interrupted. Thus, communication can be restarted.

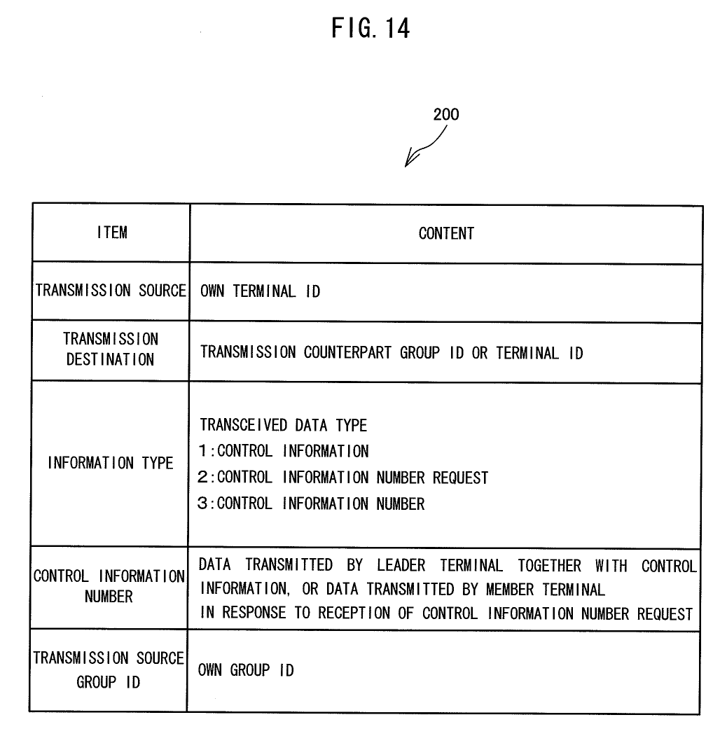

Next, the second embodiment will be described with reference to FIG. 14 to FIG. 19. In the second embodiment, a control information number (an identifier) for identifying transmission in a given cycle from another cycle of transmission is transmitted when the leader terminal 1 transmits control information. Then, the new leader terminal 3 collects the control information number from each of the member terminals, thereby identifying the communication restart group.

In the wireless communication system 100 according to the second embodiment, data shown in FIG. 14 is transmitted and received. As shown in FIG. 14, transceived data 200 includes five items, i.e., transmission source information, transmission destination information, information type, control information number, and transmission source group ID. The ID of the terminal (own terminal ID) that transmits the data is set in the transmission source information. The ID of the group (own group ID) to which the terminal that transmits the data belongs is set in the transmission source group ID. The group ID or the terminal ID of the transmission counterpart is set in the transmission destination information. Since broadcast communication is performed in the wireless communication system 100, the ID of the transmission counterpart is essential. When the transmission destination information of the received data matches the own terminal ID or the ID of the group to which the terminal itself belongs, the terminal determines that the data is targeted to itself. One of the values 1 to 3 is set in the information type. More specifically, the values are assigned as follows: 1: control information (leader terminal 1→member terminal 2), 2: control information number request (new leader terminal 3→member terminal 2), and 3: control information number (member terminal 2→new leader terminal 3). When the information type is 1 or 3, data of the control information number is set and transmitted.

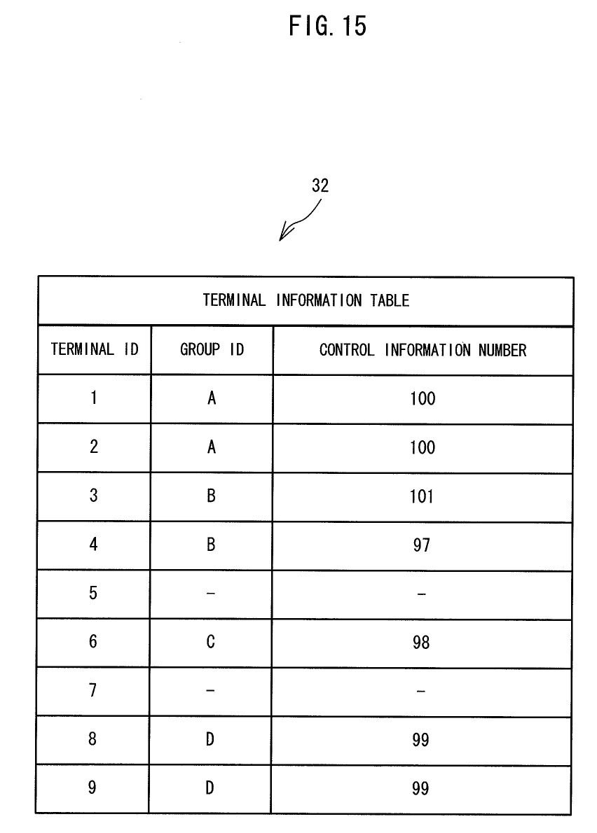

A sequential number is assigned as the control information number every time the leader terminal 1 transmits control information, and the sequential number is transmitted, as the control information number, together with the control information. Accordingly, in the second embodiment, data of the respective items, i.e., the terminal ID, the group ID, and the control information number, is stored in the terminal information table stored in the terminal information storage area 32 as shown in FIG. 5. An example shown in FIG. 15 shows a state where the control information numbers are collected from the member terminals 2 in a new leader terminal process that is described later. In this example, the terminal 1 and the terminal 2 that belong to the group A stored and transmitted the control information number 100 to the new leader terminal 3. The control information numbers of the terminal 3 and the terminal 4 that belong to the group B are 101 and 97, respectively. The control information number of the terminal 6 that belongs to the group C is 98, and the control information numbers of the terminal 8 and the terminal 9 that belong to the group D are both 99. Thus, it can be found that the control information was transmitted in the following order: group B (97)→group C (98)→group D (99)→group A (100)→group B (101), and that communication was interrupted by a failure during transmission to the group B. Note that, in the second embodiment, a sequential control information number is used as an identifier for indicating transmission timing of the control information. However, any identifier other than a number may be used as long as it can identify a given cycle of transmission from another cycle of transmission, and indicate the transmission timing relationship.

A main process of the second embodiment is similar to that of the first embodiment described referring to FIG. 7. However, the contents of a leader terminal process, a member terminal process, and a new leader terminal process that are performed in the main process of the second embodiment, a control information number collection process that is performed in the new leader terminal process, and a communication restart group identification process are different. Descriptions of the main process and common processes are omitted here.

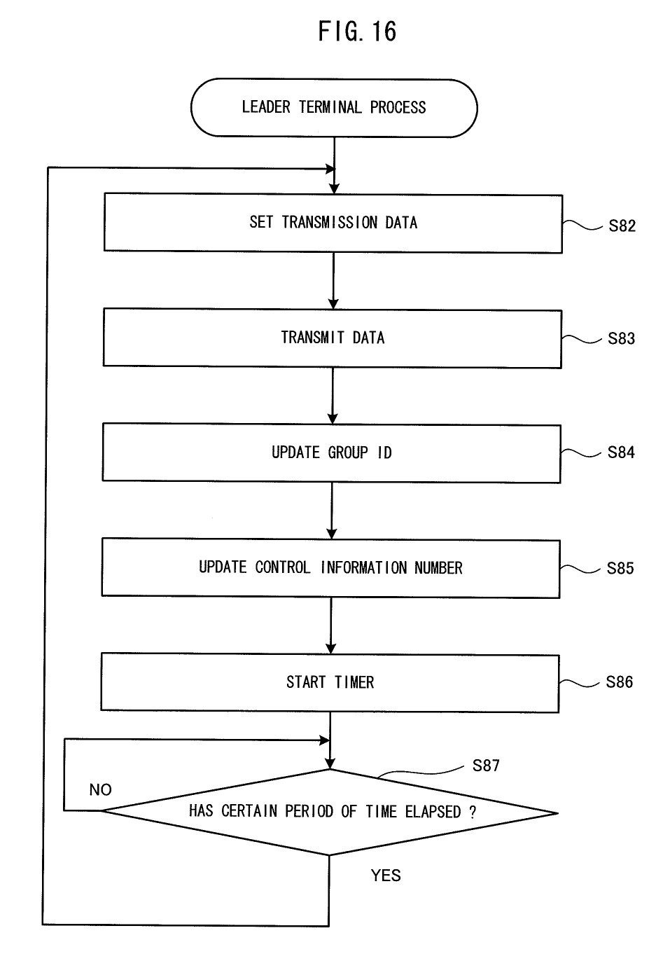

First, the leader terminal process performed in the second embodiment will be described with reference to FIG. 16. When the leader terminal process is started, first, transmission data setting for transmitting control information to the member terminals 2 is performed (step S82) As described above, in the second embodiment, the transceived data 200 is structured as shown in FIG. 14. Therefore, the own terminal ID is set in the transmission source, the ID of a group (current communication group) with which the leader terminal 1 is to perform communication from now is set in the transmission destination, and “1” is set in the information type. Then, a sequential number is assigned as the control information number and attached to the control information. The communication group is set in accordance with the transmission order stored in the transmission order storage area 36. Note that the information type “1” is the control information that causes each of the member terminals 2 to perform a certain process. The content (control content) of the process caused to be performed by each of the member terminals 2 may be determined in advance, or the control content may be transmitted in a command format with the transmission data. Examples of the process are, for example, illumination of an LED on the terminal, driving a motor, output of audio and the like.

When the transmission data setting is completed, the data is actually transmitted (step S83), and the current communication group ID is updated with the next group ID in the transmission order, in accordance with the transmission order stored in the transmission order storage area 36 (step S84). Then, a timer is started (step S86), and after a certain period of time has elapsed (step S87), the process returns to step S81 to perform communication with the next group. The above processing is repeatedly performed in the leader terminal process.

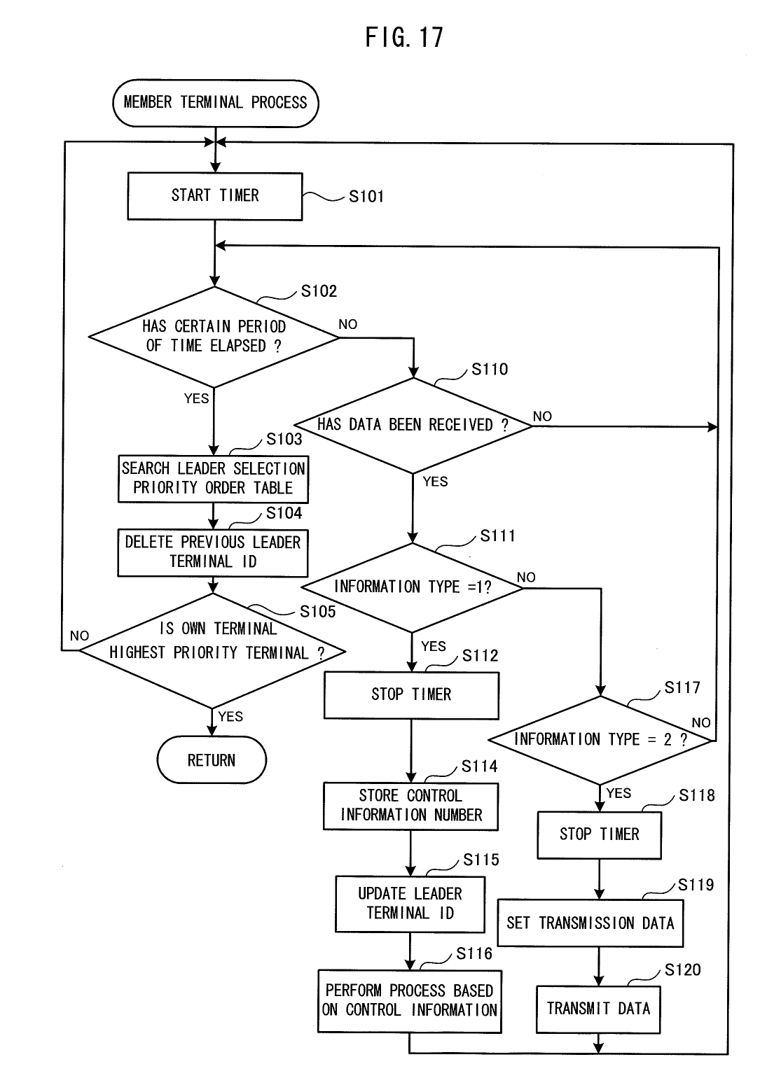

Next, the member terminal process performed in the second embodiment will be described with reference to FIG. 17. The member terminal process is performed when the terminal state is not “1” (no at step S70) in the main process shown in FIG. 7. In the member terminal process, when data is received from the leader terminal 1, processing in accordance with the information type of the received data is performed. In addition, time is measured using the timer. When no data is transmitted from the leader terminal 1 after the certain period of time has elapsed, it is determined that a failure has occurred in communication with the leader terminal 1. Then, it is determined whether the terminal itself should be the new leader terminal 3 in accordance with the leader selection priority order table.

When the member terminal process is started, first, the timer is started in order to measure the time required to receive the control information from the leader terminal 1 (step S101). Next, it is determined whether a certain period of time has elapsed (step S102). When the certain period of time has elapsed (yes at step S102), there is a failure in communication with the leader terminal 1. Therefore, then, the leader selection priority order table stored in the priority order storage area 31 is searched (step S103). Then, information corresponding to the terminal ID of the previous leader terminal 1, which is stored in the current leader terminal storage area 35, is deleted from the terminal information table (refer to FIG. 15) that is stored in the terminal information storage area 32 (step S104). For example, if the previous leader terminal 1 is the communication terminal with the terminal ID “2”, the record of the terminal ID “2” is deleted.

Next, it is determined, based on the search result at step S103, whether the terminal itself is the highest priority terminal. This can be determined based on whether the own terminal ID is the terminal ID that is next, in the priority order, to the terminal ID of the leader terminal 1 stored in the current leader terminal storage area 35. When the terminal itself is the highest priority terminal (yes at step S105), the process returns to the main process once in order to perform the processing as the new leader terminal 3. When the terminal itself is not the highest priority terminal (no at step S105), the process returns to step S101 in order to wait for another priority terminal to complete the processing as the new leader terminal 3, and the timer is started again.

When the certain period of time has not elapsed at step S102 (no at step S102), it is determined whether data has been received (step S110). When data has not been received (no at step S110), the process returns to step S102 and it is determined whether the certain period of time has elapsed. When data has been received (yes at step S110), it is determined whether the received information type is “1” (step S111). When the received information type is “1” (yes at step S111), the data is the control information from the leader terminal 1. Therefore, the timer is stopped (step S112), and the control information number is updated and stored in a control information number storage area (not shown in the figures) of the RAM 30 (step S114). Then, the current leader terminal ID is extracted from the transmission source information of the received data, and stored in the current leader terminal storage area 35 (step S115). Then, the process specified by the control information is performed (step S116), and the process returns to step S101 where the timer is started again.

When the information type of the received data is not “1” (no at step S111), next, it is determined whether the information type is “2” (step S117). When the information type is “2” (yes at step S117), the data is a request from the new leader terminal 3 for transmission of the control information number. Therefore, the timer is stopped (step S118), and the transmission data is set (step S119). More specifically, the own terminal ID is set in the transmission source, the transmission source terminal ID (the terminal ID of the new leader terminal 3) of the received data is set in the transmission destination, and the information type is set to “3”. The information type “3” indicates transmission of the control information number. Then, the control information number stored in the control information number storage area of the RAM 30 is extracted and set. In addition, the own group ID is stored as the transmission source group ID. Next, the set data is transmitted (step S120), and the process returns to step S101 where the timer is started again.

As described above, the member terminal process is repeatedly performed while data is transmitted from the leader terminal 1. Only when transmission from the leader terminal 1 is interrupted and the terminal itself becomes the new leader terminal 3, does the process return to the main process.

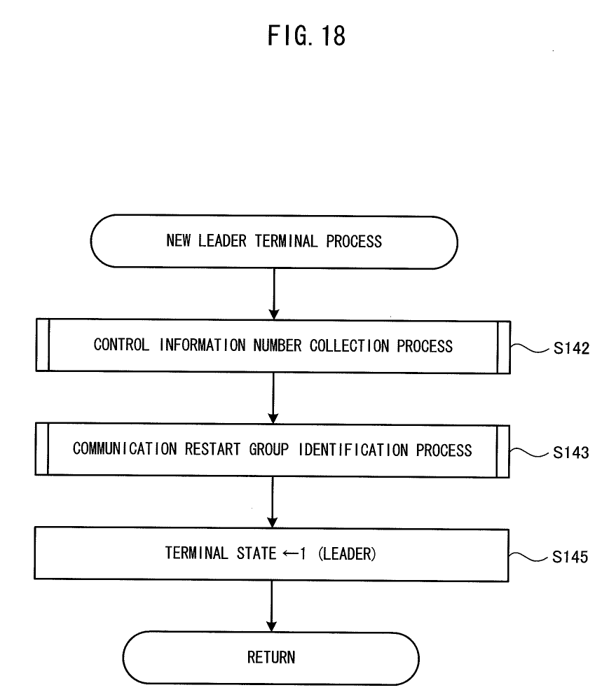

Next, the new leader terminal process will be described with reference to FIG. 18 to FIG. 20. The new leader terminal process is performed when, in the member terminal process (refer to FIG. 17), no data is transmitted from the leader terminal 1 after the certain period of time has elapsed (yes at step S102 of FIG. 17), and further, the terminal itself is set as the highest priority terminal by the leader selection priority order table (yes at step S105 of FIG. 17).

As shown in FIG. 18, when the new leader terminal process is started, first, in order to collect the control information numbers from the member terminals 2, the control information number collection process is performed (step S142). In this process, a control information number transmission request is transmitted to each group, and the control information number is received from each of the member terminals 2. Then, based on the collected control information numbers, a communication restart group identification process for identifying the group with which communication is to be restarted is performed (step S143). Then, the terminal state is set to “1” (step S145), and the process returns to the main process. As a result, in the next processing cycle, the “terminal state=1” and the terminal itself becomes the leader terminal 1 (yes at step S70 of FIG. 7). Therefore, the leader terminal process is performed.

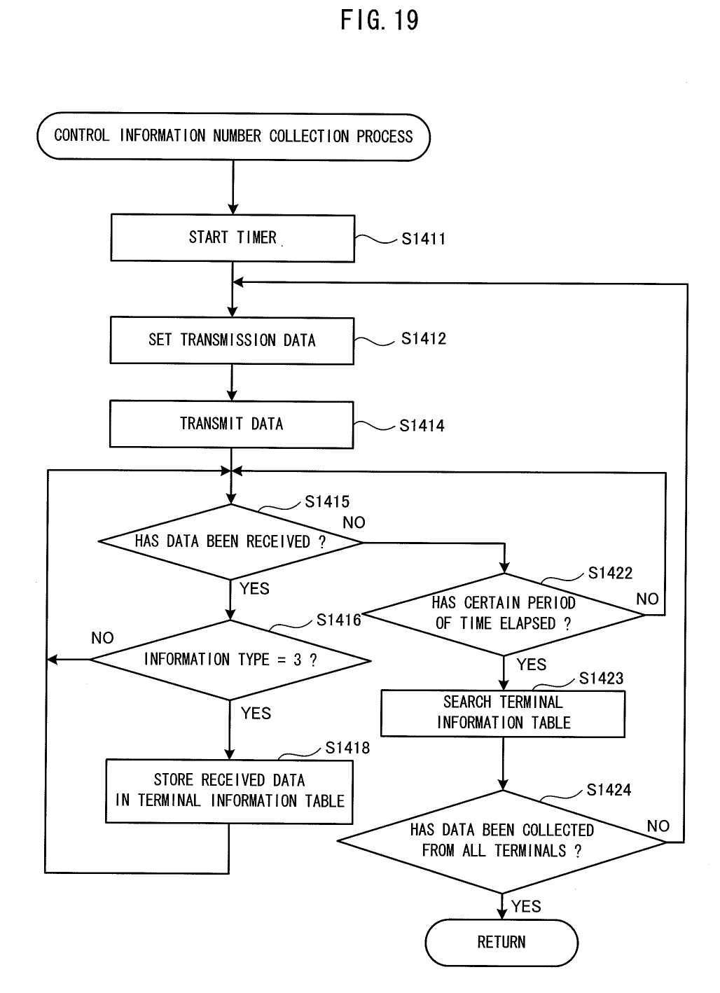

Here, details of the control information number collection process will be described with reference to FIG. 19. As shown in FIG. 19, when the control information number collection process is started, first, the timer is started (step S1411). Then, the transmission data for requesting each member terminal to transmit the control information number is set (step S1412). More specifically, the own terminal ID is set in the transmission source, and the ID of the terminal whose control information number has not yet been registered in the terminal information table in the terminal information storage area 32 is set in the transmission destination, and the information type is set to “2”. The information type “2” indicates the request for the control information number.

Next, the set data is transmitted (step S1414), and it is determined whether data has been received (step S1415) When data has been received (yes at step S1415), it is determined whether the information type of the received data is “3” (step S1416). The information type “3” is the data of the control information number that the member terminal 2 transmits in response to transmission of the data of the information type “2”. When the information type is “3” (yes at step S1416), the terminal ID, the group ID, and the control information number are extracted from the received data, and registered in the terminal information table and stored in the terminal information storage area 32 (step S1418).

When data has not been received (no at step S1415), it is determined whether a certain period of time has elapsed from the timer start at step S1411 (step S1422). When the certain period of time has not elapsed (no at step S1422), the process returns to step S1415 to wait for data reception.

When the certain period of time has elapsed (yes at step S1422), the terminal information table is searched (step 91423), and it is determined whether data has been obtained from all the terminals (step S1424). When data from all the terminals has been collected (yes at step S1424), the process returns to the new leader terminal process. When data from all the terminals has not been collected (no at step S1424), the process returns to step S1412. Then, the terminal information table is searched, and a control information number request is made for the terminal ID whose control information number is not yet registered. Due to the above-described control information number collection process, the control information numbers of all the terminals that are currently communicable in the wireless communication system 100 are registered in the terminal information table in the terminal information storage area 32.

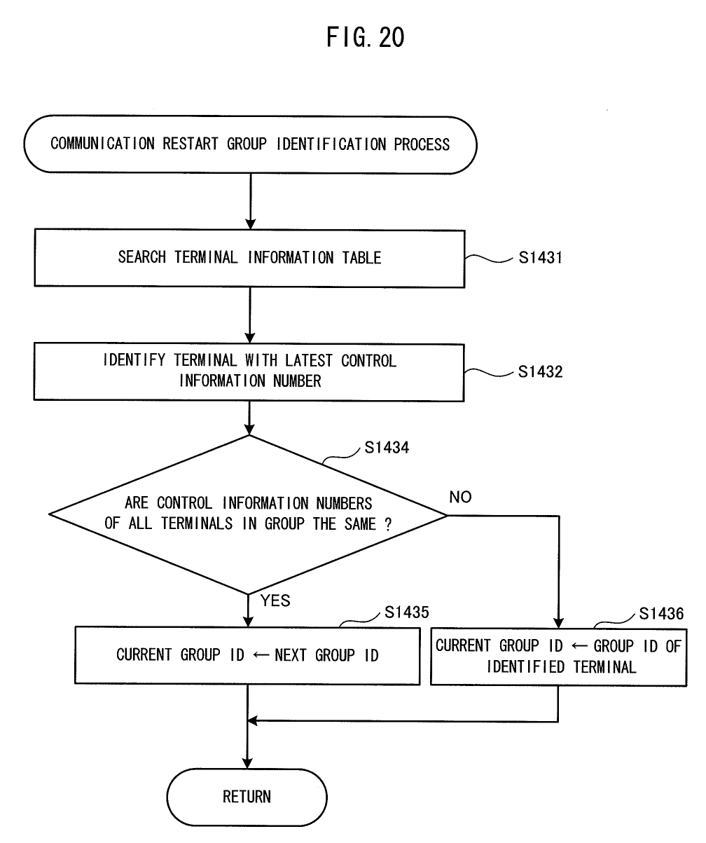

Next, details of the communication restart group identification process will be described with reference to FIG. 20. The communication restart group identification process determines to which group the new leader terminal 3 should next transmit the control information, based on the control information numbers in the respective terminals collected by the control information number collection process.

As shown in FIG. 20, when the communication restart group identification process is started, first, the terminal information table (refer to FIG. 15) in the terminal information storage area 32 is searched (step S1431). Next, the terminal that has the latest control information number in the terminal information table is identified (step S1432). For example, when the terminal information table is in the state shown in FIG. 15, the terminal that has the latest control information number is identified as the terminal with the terminal ID “3,” whose control information number is “101”.

Next, it is determined whether the control information numbers of all the terminals that belong to the same group (group B to which the terminal 3 belongs, in the example shown in FIG. 15) as that of the terminal identified at step S1432 are the same (step S1434). Normally, the terminals in the same group receive the same control information number. Therefore, if the control numbers of the terminals in the same group are the same (yes at step S1434), reception has been completed normally in that group. Thus, the group next to the group to which the terminal identified at step S1432 belongs is identified as the group to be communicated with (step S1435), For example, if the communication order of groups is set as A, B, C, D . . . , and if the group of the identified terminal is B, the ID of the group (current group) to be communicated with is determined as “C”. Then, the process returns to the new leader terminal process. The group identified here is the group to which the control information will be transmitted when the process returns to the main process (refer to FIG. 7) and the leader terminal process is performed (refer to step S82 of FIG. 16).

When the control information numbers of the terminals in the same group are not the same (no at step S1434), it is conceivable that a failure has occurred during communication with the group. Therefore, it is determined that communication is to be first performed with that group (step S1436). For example, in the case of FIG. 15, the terminals of the group B to which the terminal 3 belongs are the terminals 3 and 4. However, the control information number of the terminal 3 is “101”, and the control information number of the terminal 4 is “97”. In this case, the control information with the same content as that transmitted to the terminal 3 has not been transmitted to the terminal 4. Therefore, the current group ID is set to “B” in order to restart communication from the group B. Then, the process returns to the new leader terminal process. The group identified here is the group to which the control information will be transmitted when the process returns to the main process (refer to FIG. 7) and the leader terminal process is performed (refer to step S82 of FIG. 16).

As described above, in the wireless communication system 100 of the second embodiment, each communication terminal stores the IDs of all the terminals in the terminal information table. Further, the priority order of terminals that should function as the leader terminal 1 is stored as the leader selection priority order table. Moreover, whether the terminal itself is currently the leader terminal 1 or the member terminal 2 is identified based on the terminal state. When the terminal state is “1”, the processing as the leader terminal 1 is performed, and when the terminal state is not “1”, the processing as the member terminal 2 is performed. In the processing as the leader terminal 1, the control information is transmitted to each group so as to cause each of the member terminals 2 to perform a certain process. Further, every time the control information is transmitted, a sequential control information number relating to the transmission is assigned and transmitted together with the control information. In the processing as the member terminal 2, the process in accordance with the control information received from the leader terminal 1 is performed. In addition, the control information number transmitted together with the control information is stored. If data transmitted from the leader terminal 1 cannot be received in a certain period of time, it is determined whether the terminal itself becomes the new leader terminal 3 by referring to the stored leader selection priority order table. When the terminal itself becomes the new leader terminal 3, it requests the other terminals to send the control information number. Then, the new leader terminal 3 identifies, as the communication restart group, the group of the terminal having the latest number (the largest number) among the obtained control information numbers, or the group next to that group. When the terminal itself does not become the new leader terminal 3, it transmits the control information number in response to the request from the new leader terminal 3. Therefore, even when communication from the leader terminal 1 is interrupted by, for example, presence of an obstruction, movement of the leader terminal 1, or failure of the leader terminal 1, one of the member terminals can function as the new leader terminal in accordance with the priority order. Moreover, the control information numbers are collected and used to determine up to which group transmission of the control information was completed when the communication was interrupted. Thus, communication can be restarted. The use of the control information number makes it possible to identify the communication restart group more reliably than the use of the reception time.

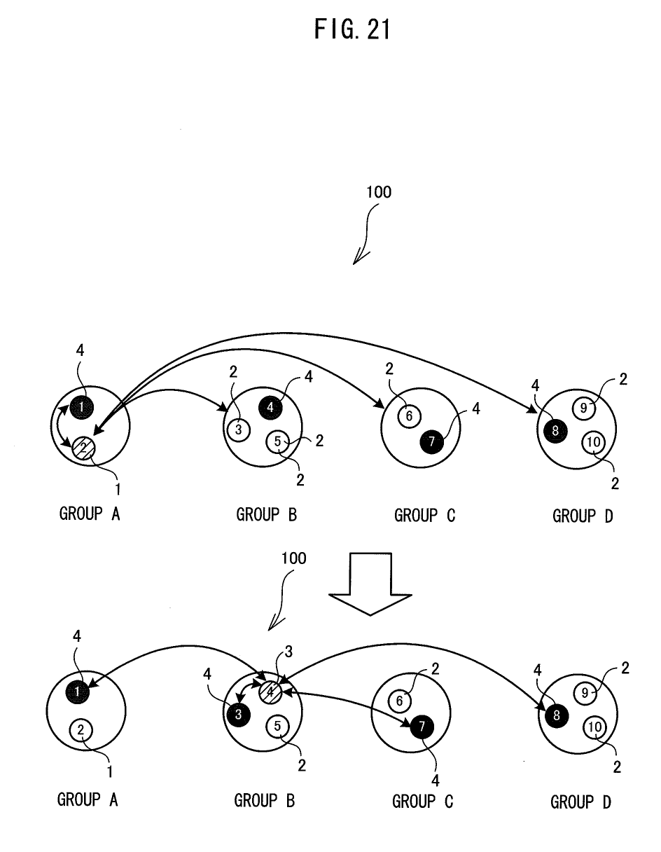

Next, the third embodiment will be described with reference to FIG. 21 to FIG. 29. In the third embodiment, one of the terminals in each group is set as a group leader terminal, and the group leader terminal collects information of the member terminals in the group when the new leader terminal 3 collects information. The new leader terminal 3 collects information about each group from each group leader terminal.

In the wireless communication system 100 according to the third embodiment shown in the upper section of FIG. 21, a plurality of wireless communication terminals are performing ad-hoc communication in the same manner as in the first and second embodiments. Each of the wireless communication terminals has the same physical structure, and functions either as the leader terminal 1 or the member terminal 2. In the wireless communication system 100, a plurality of groups (four groups, i.e., group A, group B, group C and group D in FIG. 21) are present, and the leader terminal 1 and the member terminal 2 belong to one of the groups. The leader terminal 1 performs synchronous communication in group units. Further, a group leader terminal 4 is set for each group.

When the leader terminal 1 becomes unable to communicate (out of the communication range, a shield, failure, etc.) as shown in the lower section of FIG. 21, the new leader terminal 3 is selected from among the group leader terminals 4 in accordance with an order of priority determined in advance. The new leader terminal 3 causes each of the group leader terminals 4 to collect the latest reception time at which each of the member terminals 2 in the group received the control information from the previous leader terminal 1, and collects a reception time list from each of the group leader terminals 4. Then, based on the collected data, the new leader terminal 3 identifies the group with which communication is to be restarted.

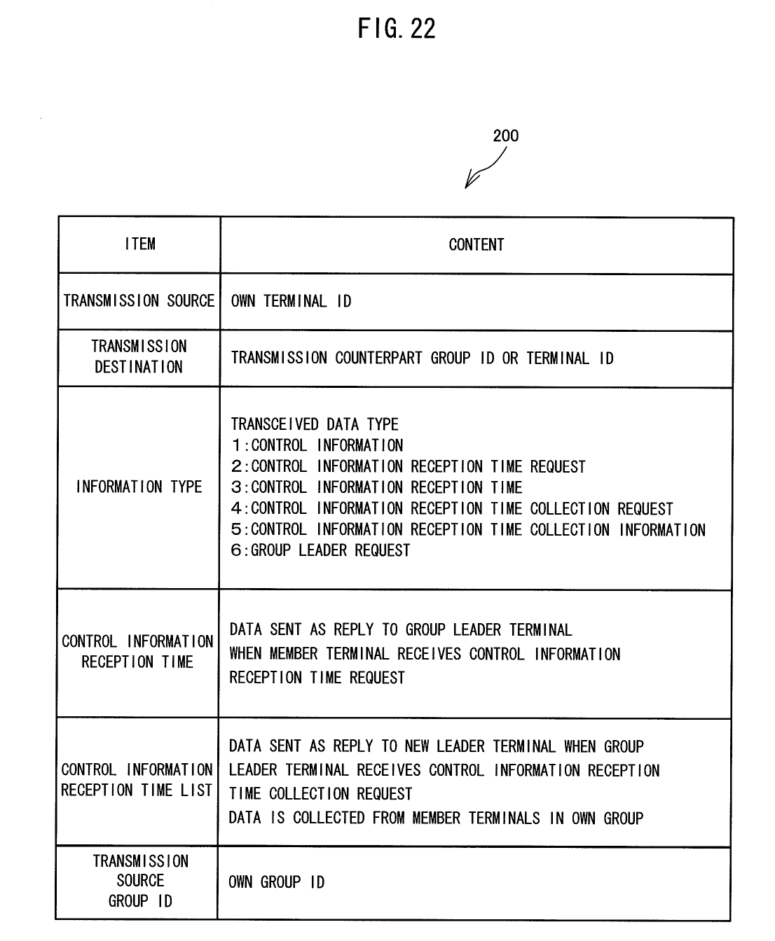

In the wireless communication system 100 of the third embodiment, data shown in FIG. 22 is transmitted and received. As shown in FIG. 22, transceived data 200 includes six items, i.e., transmission source information, transmission destination information, information type, control information reception time, control information reception time list, and transmission source group ID. The ID of the terminal that transmits the data is set in the transmission source information. The ID of the group to which the terminal that transmits the data belongs is set in the transmission source group ID. The group ID or the terminal ID of the transmission counterpart is set in the transmission destination information. When the transmission destination information of the received data matches the own terminal ID or the ID of the group to which the terminal itself belongs, the terminal determines that the data is targeted to itself. One of the values 1 to 6 is set in the information type. More specifically, the values are assigned as follows: 1; control information (leader terminal 1→member terminal 2), 2; control information reception time request (group leader terminal 4→member terminal 2), 3: control information reception time (member terminal 2→group leader terminal 4), 4: control information reception time collection request (new leader terminal 3→group leader terminal 4), 5: control information reception time collection information (group leader terminal 4→new leader terminal 3), and 6: group leader request (new leader terminal 3→new group leader terminal 4). When the information type is 3, data of the control information reception time is set, and when the information type is 5, the control information reception time list is transmitted.

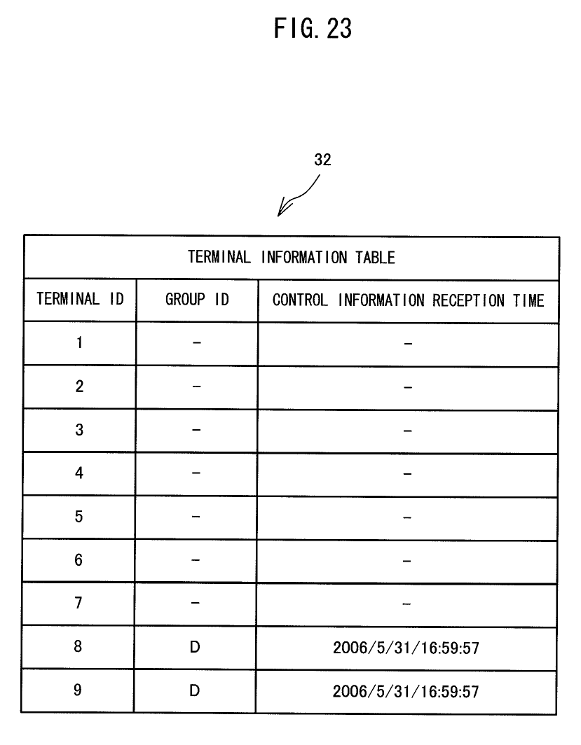

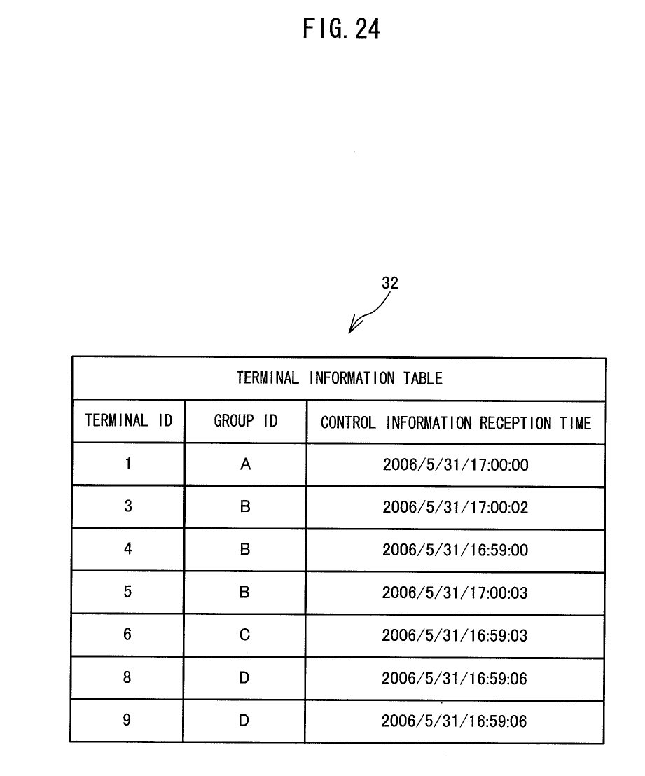

In the third embodiment, when the new leader terminal 3 is determined, each of the group leader terminals 4 collects the control information reception time from each of the member terminals 2 in the group. The collected control information reception times are stored in the terminal information storage area 32. Because only information of the member terminals in the group leader terminal 4's own group is collected, the obtained table shown in FIG. 23 includes no data in sections relating to the terminals in the other groups. The group leader terminal 4 extracts only the sections that include the data and transmits them to the new leader terminal 3 as the control information reception time list. The new leader terminal 3 synthesizes the control information reception time lists transmitted from the group leader terminals 4 to form the terminal information table for all the terminals shown in FIG. 24.

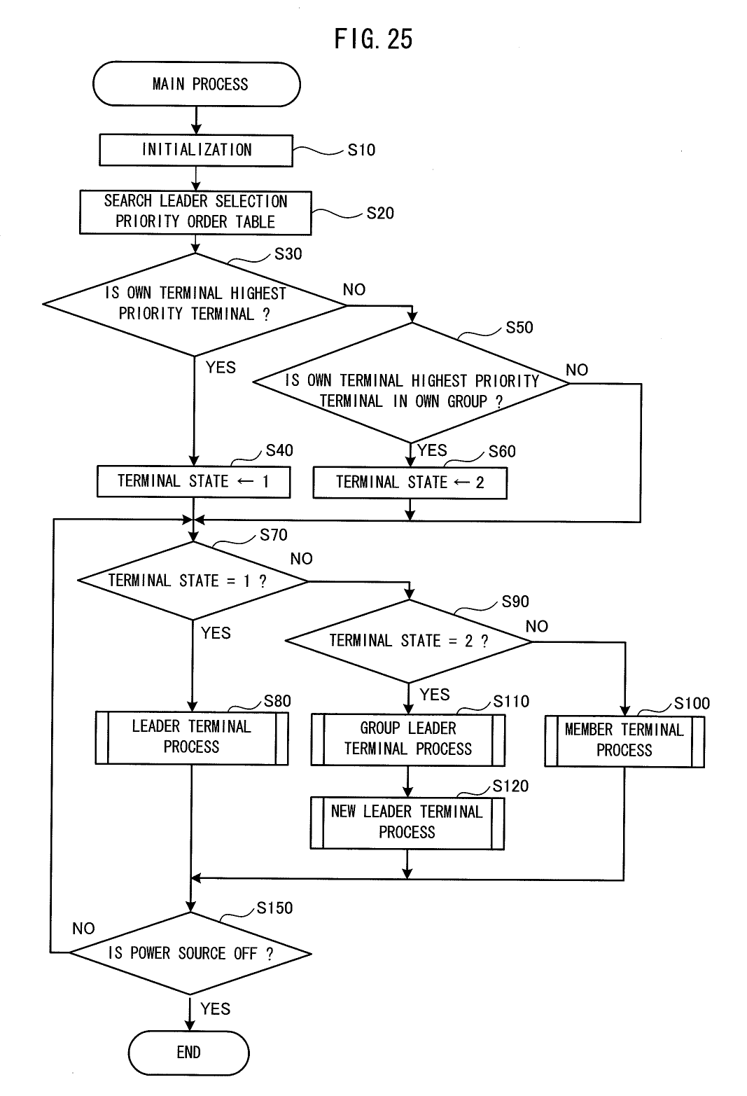

In the third embodiment, each of the communication terminals repeatedly performs a main process shown in FIG. 25 from the point at which the power source is turned on until the power source is turned off. In the main process, if the terminal is currently the leader terminal 1, the processing as the leader terminal 1 is performed, if the terminal is the group leader terminal 4, the processing as the group leader terminal 4 is performed, and if the terminal is the member terminal 2, the processing as the member terminal 2 is performed. Further, in the processing as the group leader terminal 4, if the control information is not transmitted from the leader terminal 1 after a certain period of time has elapsed, and if the terminal itself is the highest in the priority order, the processing as the new leader terminal 3 is performed.

As shown in FIG. 25, when the power source is turned on, first, an initialization process that clears the storage area of the RAM 30 is performed (step S10). Then, the leader selection priority order table stored in the priority order storage area 31 is searched (step S20). As a result of the search, if the terminal itself is the highest priority terminal (yes at step S30), it stores “1” in the terminal state storage area 33 in order to perform the processing as the leader terminal 1. Here, “terminal state=1” indicates that the terminal itself is the leader terminal 1.

When the terminal itself is not the highest priority terminal (no at step S30), then, it is determined whether the terminal itself is the highest priority terminal in the group to which the terminal itself belongs (hereinafter referred to as the “own group”). When the terminal itself is the highest priority terminal in the own group (yes at step S50), it stores “2” in the terminal state storage area 33 in order to perform the processing as the group leader terminal 4. Here, “terminal state=2” indicates that the terminal itself is the group leader terminal 4. As described above, in the third embodiment, the group leader terminal 4 is the highest priority terminal among the terminals in each of the groups.

If the terminal itself is not the highest priority terminal in the own group (no at step S30), the process directly proceeds to step S70. For example, in the case of the leader selection priority order table shown in FIG. 4, the communication terminal whose terminal ID is “1” satisfies “terminal state=1”, the communication terminals whose terminal IDs are “3”, “5” and “8” satisfy “terminal state=2”, and the other terminals directly proceed to the processing at step S70.

Next, it is determined whether the terminal state is “1” (leader terminal 1) by referring to the terminal state storage area 33 (step S70). In the case of the leader terminal 1 (yes at step S70), the leader terminal process is performed (step S80). The leader terminal process of the third embodiment is similar to that of the first embodiment, and a detailed description thereof is therefore omitted here.

When the terminal state is not “1” (no at step S70), then, it is determined whether the terminal state is “2” (group leader terminal 4) (step S90). In the case of the group leader terminal 4 (yes at step S90), a group leader terminal process is performed. Further, in a particular case, the new leader terminal process is performed (step S120) When the terminal state is neither “1” nor “2” (no at step S90), the member terminal process is performed (step S100).

When the leader terminal process, the new leader terminal process, or the member terminal process is completed, it is determined whether the power source is turned off (step S150). When the power source is turned off (yes at step S150), all the processes are ended. When the power source is not turned off (no at step S150), the process returns to step S70 to repeat the process.

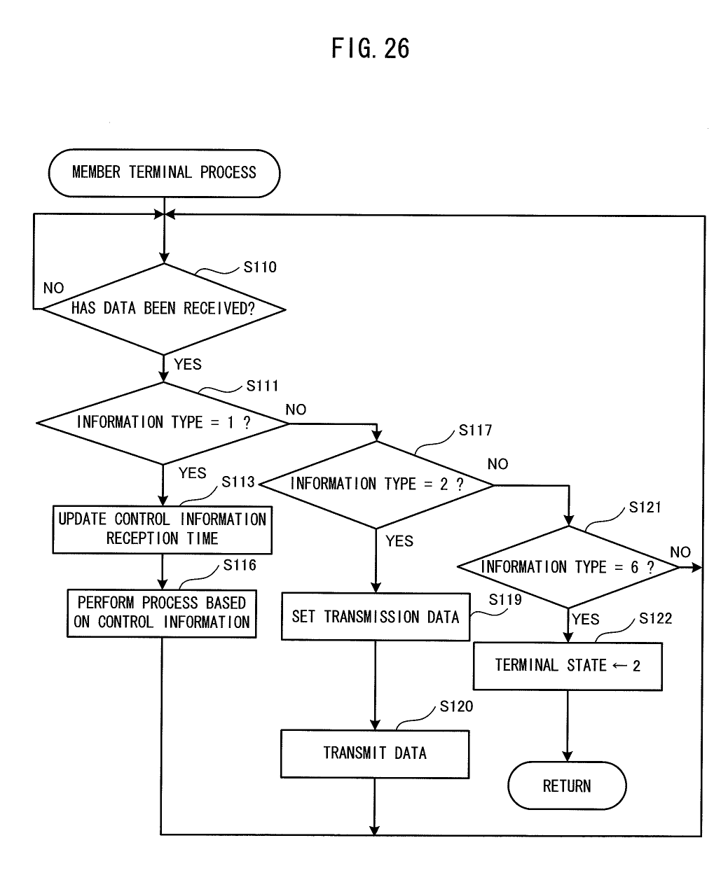

Next, the member terminal process in the third embodiment will be described with reference to FIG. 26. The member terminal process is performed when the terminal state is neither “1” nor “2” (no at step S70, no at step S90) in the main process shown in FIG. 25. In the member terminal process, when data is received from the leader terminal 1 or the group leader terminal 4, processing in accordance with the information type of the received data is performed.

When the member terminal process is started, it is first determined whether data has been received (step S110). When data has not been received (no at step S110), the process operates as it is on stand-by. When data has been received (yes at step S110), it is determined whether the received information type is “1” (step S111). When the received information type is “1” (yes at step S111), the data is the control information from the leader terminal 1. Therefore, the time at which the control information is received is stored in the reception time storage area 34, and the control information reception time is updated (step S113). Then, the process specified by the control information is performed (step S116), and the process returns to step S110 to wait for data reception.

When the information type of the received data is not “1” (no at step S111), next, it is determined whether the information type is “2” (step S117). When the information type is “2” (yes at step S117), the data is a transmission request from the group leader terminal 4 for transmission of the control information reception time. Therefore, the transmission data is set in order to transmit the control information reception time in accordance with the request (step S119). More specifically, the own terminal ID is set in the transmission source, the transmission source terminal ID (the terminal ID of the group leader terminal 4) of the received data is set in the transmission destination, and the information type is set to “3”. The information type “3” indicates transmission of the control information reception time. Therefore, the reception time stored in the reception time storage area 34 is extracted and set. In addition, the own group ID is stored as the transmission source group ID. Next, the set data is transmitted (step S120), and the process returns to step S110 to wait for data reception.

When the information type of the received data is not “2” (no at step S117), next, it is determined whether the information type is “6” (step S121). If the information type is “6” (yes at step S121), it means that the terminal is requested to serve as the next group leader terminal because the group leader terminal 4 was selected to become the new leader terminal 3. Therefore, the terminal state is set to “2” and stored (step S122). Then, the process returns to the main process. In the next cycle of the main process, the terminal state is “2”. Therefore, the processing as the group leader terminal 4 is performed (yes at step S90).

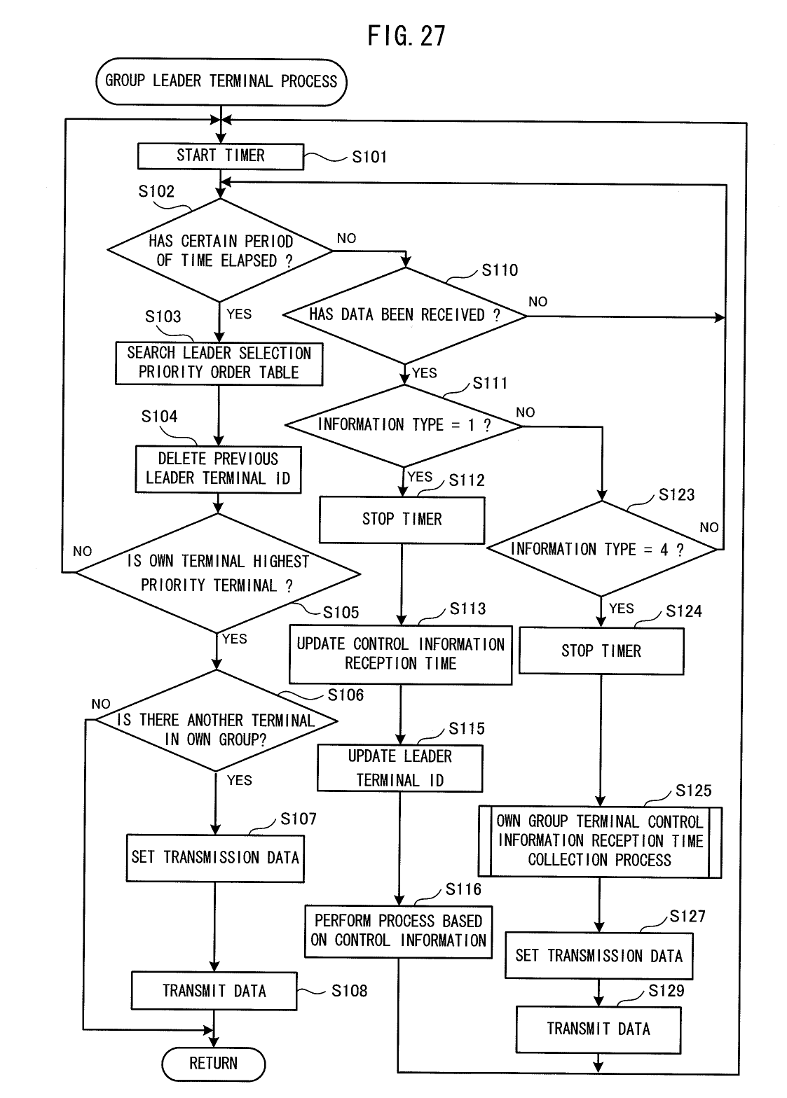

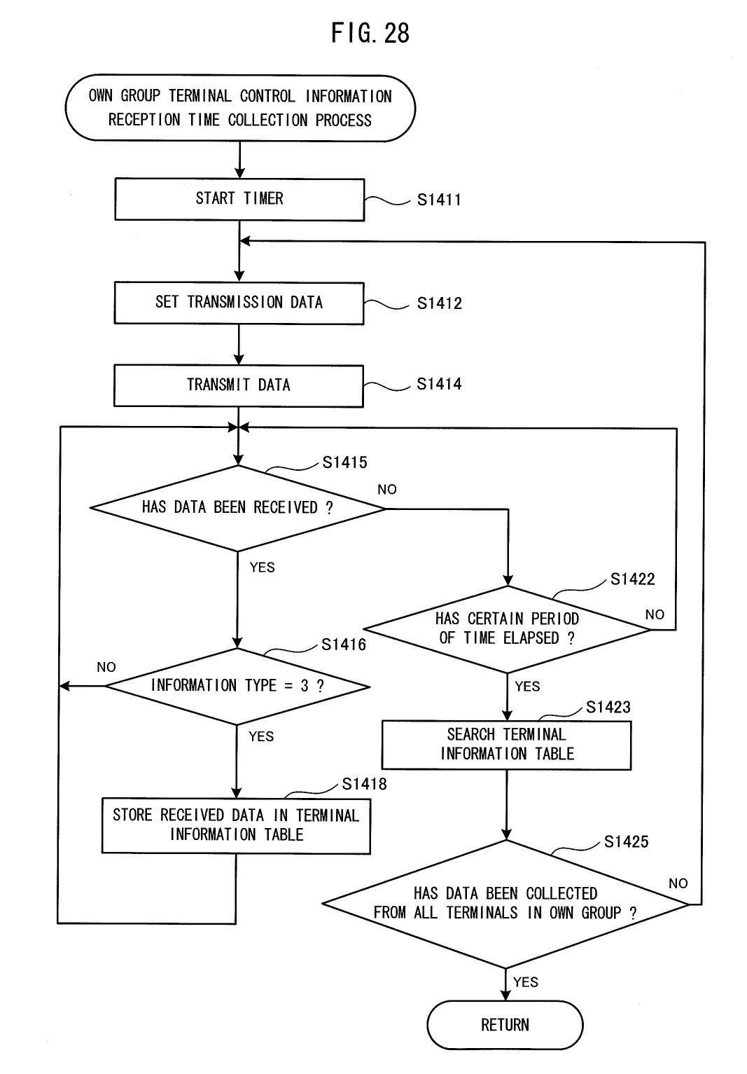

Next, the group leader terminal process will be described with reference to FIG. 27 and FIG. 28. The group leader terminal process is performed when the terminal state is “2” (yes at step S90) in the main process shown in FIG. 25. In the group leader terminal process, when data is received from the leader terminal 1 or the member terminal 2 in the own group, processing in accordance with the information type of the received data is performed. In addition, time is measured using a timer. When no data is transmitted from the leader terminal 1 after a certain period of time has elapsed, it is determined that a failure has occurred in communication with the leader terminal 1. Then, it is determined whether the terminal itself should become the new leader terminal 3 in accordance with the leader selection priority order table.

When the group leader terminal process is started, first, the timer is started in order to measure the time required to receive the control information from the leader terminal 1 (step S101). Next, it is determined whether a certain period of time has elapsed (step S102). When the certain period of time has elapsed (yes at step S102), there is a failure in communication with the leader terminal 1. Therefore, then, the leader selection priority order table stored in the priority order storage area 31 is searched (step S103). Then, information corresponding to the terminal ID of the previous leader terminal 1, which is stored in the current leader terminal storage area 35, is deleted from the terminal information table (refer to FIG. 24) stored in the terminal information storage area 32 (step S104). For example, if the previous leader terminal 1 is the communication terminal whose terminal ID is “2”, the record of the terminal ID “2” is deleted. FIG. 24 shows a state in which the records of the terminal IDs “2” and “7” have been deleted.

Next, it is determined, based on the search result at step S103, whether the terminal itself is the highest priority terminal. This can be determined based on whether the own terminal ID is the terminal ID that is next, in the priority order, to the terminal ID of the leader terminal 1 stored in the current leader terminal storage area 35. When the terminal itself is not the highest priority terminal (no at step S105), the process returns to step S101 in order to wait for another priority terminal to complete the processing as the leader terminal 1, and the timer is started again.

When the terminal itself is the highest priority terminal (yes at step S105), then, it becomes the new leader terminal 3 from that point. As a result, the terminal can no longer function as the group leader terminal 4. Therefore, it is necessary to request another terminal in the own group to function as the group leader terminal 4. First, it is determined whether there is another terminal in the own group (step S106). When there is no other terminal in the own group (no at step S106), the group leader terminal 4 is not necessary for the own group. In this case, the process returns to the main process once in order to perform the processing as the new leader terminal 3.

When there is another terminal in the own group (yes at step S106), transmission data is set in order to request another terminal in the own group to function as the group leader terminal 4 (step S107). More specifically, the own terminal ID is set in the transmission source, the new group leader terminal ID is set in the transmission destination, and “6” is set in the information type. Then, the set data is transmitted (step S108). After that, the process returns to the main process once in order to perform the processing as the new leader terminal 3.

Here, the terminal in the own group that is ranked next, in the priority order, to the terminal itself is selected, by referring to the leader selection priority order table, as the terminal in the own group requested to function as the group leader terminal 4. For example, in the example of the leader selection priority order table in FIG. 4, it is assumed that a failure has occurred in the terminal with the ID “1,” and the terminal “2” that is ranked next in the priority order is set as the new leader terminal 3. In the group B to which the terminal “2” belongs, there is a terminal other than the terminal “2” (the terminal “3”). Therefore, the terminal “2” that has functioned as the group leader terminal 4 of the group B transmits group leader request data to the terminal “3” that is the own group terminal ranked next, in the priority order, to the terminal itself.

When the certain period of time has not elapsed at step S102 (no at step S102), it is determined whether data has been received (step S110), When data has not been received (no at step S110), the process returns to step S102 and it is determined whether the certain period of time has elapsed. When data has been received (yes at step S110), it is determined whether the received information type is “1” (step S111). When the received information type is “1” (yes at step S111), the data is the control information from the leader terminal 1. Therefore, the timer is stopped (step S112), and the time at which the control information is received is stored in the reception time storage area 34, and the control information reception time is updated (step S113). After that, the current leader terminal ID is extracted from the transmission source information of the received data and stored in the current leader terminal storage area 35 (step S115). Then, the process specified by the control information is performed (step S116), and the process returns to step S101 where the timer is started again.

When the information type of the received data is not “1” (no at step S111), then, it is determined whether the information type is “4” (step S123). When the information type is “4” (yes at step S123), the data is a request from the new leader terminal 3 that requests the group leader terminal 4 to collect the control information reception time of each of the member terminals 2 in the group and transmit the result. Therefore, the timer is stopped (step S124), and the transmission data is set (step S119) in order to perform the process for collecting the control information reception time from each of the member terminals 2 in the own group (step S125) and to transmit a list obtained as a result thereof. More specifically, the own terminal ID is set in the transmission source, the transmission source terminal ID (the terminal ID of the new leader terminal 3) of the received data is set in the transmission destination, and the information type is set to “5”. The information type “5” indicates transmission of control information reception time collection information. Therefore, the control information reception times of the member terminals in the own group are extracted from the terminal information table stored in the terminal information storage area 32 and set. Then, the set data is transmitted (step S129), and the process returns to step S101 where the timer is started again.

Here, an own group terminal control information reception time collection process in which the group leader terminal 4 collects control information reception time from each of the member terminals 2 in the own group will be described with reference to FIG. 28.

When the own group terminal control information reception time collection process is started, first, the timer is started (step S1411). Then, transmission data is set in order to request each of the member terminals 2 to transmit the reception time (step S1412). More specifically, the own terminal ID is set in the transmission source, the ID of the own group is set in the transmission destination, and the information type is set to “2”. The information type “2” indicates the request for the control information reception time. Because the ID of the own group is set in the transmission destination, all the terminals in the own group are targeted.

Next, the set data is transmitted (step S1414), and it is determined whether data has been received (step S1415) When data has been received (yes at step S1415), it is determined whether the information type of the received data is “3” (step S1416). As described earlier, the information type “3” is the data of the control information reception time that the member terminal 2 transmits in response to transmission of the data of the information type “2” (refer to step S119 of FIG. 26). When the information type is “3” (yes at step S1416), the terminal ID, the group ID, and the control information reception time are extracted from the received data, and registered in the terminal information table and stored in the terminal information storage area 32 (step S1418). Then, the process returns to step S1415 to wait for data receptor. When the information type is not “3” (no at step S1416), the process returns to step S1415 to wait for data reception again.

When data has not been received (no at step S1415), it is determined whether a certain period of time has elapsed from the start of the timer at step S1411 (step S1422), When the certain period of time has not elapsed (no at step S1422), the process returns to step S1415 to wait for data reception.

When the certain period of time has elapsed (yes at step S1422), the terminal information table is searched (step S1423), and it is determined whether data has been obtained from all the terminals in the own group (step S1425). When data from all the terminals in the own group has been collected (yes at step S1425), the process returns to the group leader terminal process. When data from all the terminals has not yet been collected (no at step S1425), the process returns to step S1412, and the control information reception time request is made for all the terminals in the own group again.

Due to the above-described own group terminal control information reception time collection process, the latest reception time data of all the terminals that are present in the own group and currently communicable are registered in the terminal information table in the terminal information storage area 32. FIG. 23 shows a state of the terminal information table of the group leader terminal 4 in the group D when the own group terminal control information reception time collection process is completed.

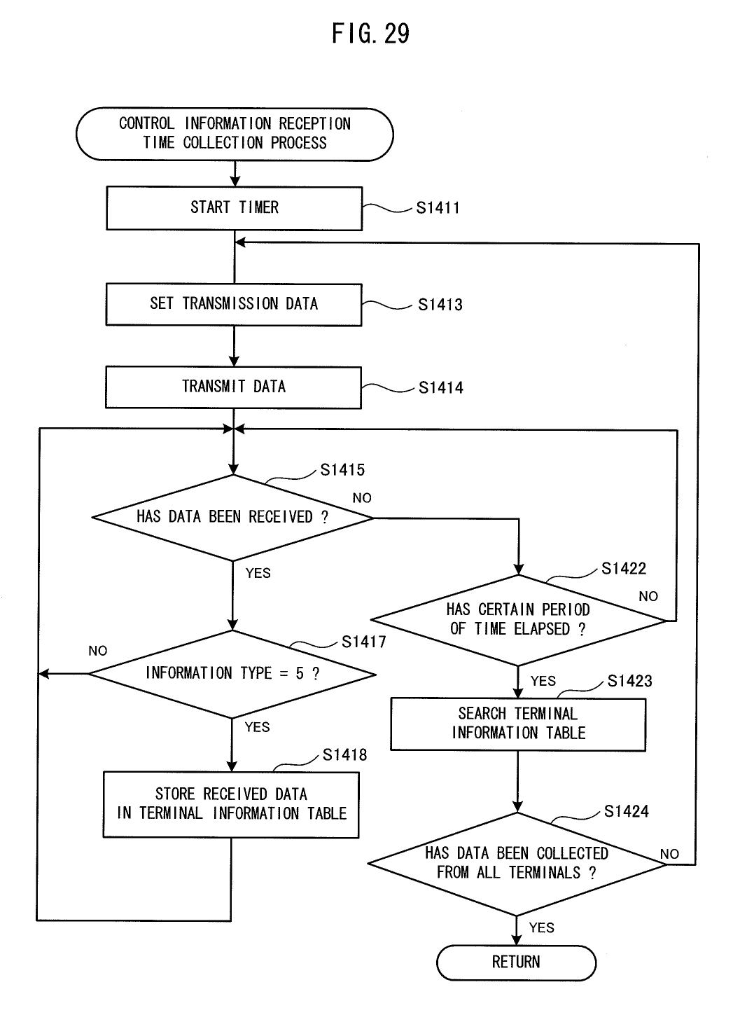

Note that when, in the third embodiment, the process proceeds to the new leader terminal process (yes at step S105 of FIG. 27 and step S120 of FIG. 25) as a result of performing the group leader terminal process in the main process (step S110 of FIG. 25), the new leader terminal process is performed in the same manner as in the first embodiment. However, a control information reception time collection process performed in the new leader terminal process is different. Details of this process will be described with reference to FIG. 29.

As shown in FIG. 29, when the control information reception time collection process is started, first, the timer is started (step S1411). Then, transmission data for requesting each of the group leader terminals 4 to transmit reception time is set (step S1413). More specifically, the own terminal ID is set in the transmission source, the ID of each of the group leader terminals 4 is set in the transmission destination, and the information type is set to “4”. The information type “4” indicates the request for the control information reception times of the member terminals in each group.

Next, the set data is transmitted (step S1414), and it is determined whether data has been received (step S1415). When data has been received (yes at step S1415), it is determined whether the information type of the received data is “5” (step S1416) As described earlier, the information type “5” is the list of the control information reception times of the member terminals in the group that is transmitted by the group leader terminal 4 in response to transmission of the data of the information type “4” (refer to step S127 of FIG. 27). When the information type is “5” (yes at step S1417), the terminal ID, the group ID, and the control information reception time are extracted from the received data, and registered in the terminal information table and stored in the terminal information storage area 32 (step S1418).

When data has not been received (no at step S1415), it is determined whether a certain period of time has elapsed from the start of the timer at step S1411 (step S1422). When the certain period of time has not elapsed (no at step S1422), the process returns to step S1415 to wait for data reception.

When the certain period of time has elapsed (yes at step S1422), the terminal information table stored in the terminal information storage area 32 is searched (step S1423), and it is determined whether data has been obtained from all the terminals (step S1424). When data from all the terminals has been collected (yes at step S1424), the process returns to the new leader terminal process. When data from all the terminals has not yet been collected (no at step S1424), the process returns to step S1412, and the control information reception time request is made to the group leader terminal 4 again.

Due to the above-described control information reception time collection process, the latest reception time data of all the terminals that are currently communicable in the wireless communication system 100 are registered in the terminal information table in the terminal information storage area 32. Based on the thus obtained latest reception time data of the terminals, a communication restart group identification process is performed in the same manner as in the first embodiment. Thus, the group with which communication is to be restarted is identified, and communication will be continued under the new leader terminal 1 without trouble.

As described above, in the wireless communication system 100 of the third embodiment, the highest priority terminal in each of the groups is set as the group leader terminal 4. Normally, the group leader terminal 4 performs processing in accordance with the control information from the leader terminal 1 like the member terminals 2. If a failure occurs in the leader terminal 1, the highest priority terminal among the group leader terminals 4 is selected as the new leader terminal 3. The previous group leader terminal 4 that has been selected as the new leader terminal 3 requests the member terminal 2 that is ranked next in the priority order in the own group to function as the group leader terminal 4. The new leader terminal 3 requests each of the group leader terminals 4, not each of the member terminals 2 individually, to collect the control information reception times of the member terminals 2 in each of the groups and transmit a list. Each of the group leader terminals 4 requests each of the member terminals 2 in the group to send the control information reception time, and accumulates the obtained information in the terminal information table. When information of all the terminals in the group is collected, each of the group leader terminals 4 transmits the information in the form of a list to the new leader terminal 3. The new leader terminal 3 synthesizes the lists transmitted from all the group leader terminals 4 to form a terminal information table of all the terminals. Based on this table, the new leader terminal 3 identifies the group with which communication is to be restarted. Therefore, even when the number of terminals is increased, the control information reception time from each of the terminals can be effectively collected, and communication can be restarted smoothly.

Note that, in the third embodiment, the control information reception time is used as information collected from each terminal, in the same manner as in the first embodiment. However, like the second embodiment, the leader terminal 1 may transmit a control information number together with the control information, and the group leader terminal 4 may collect the control information number from each member terminal 2 and transmit the collected numbers to the new leader terminal 3.

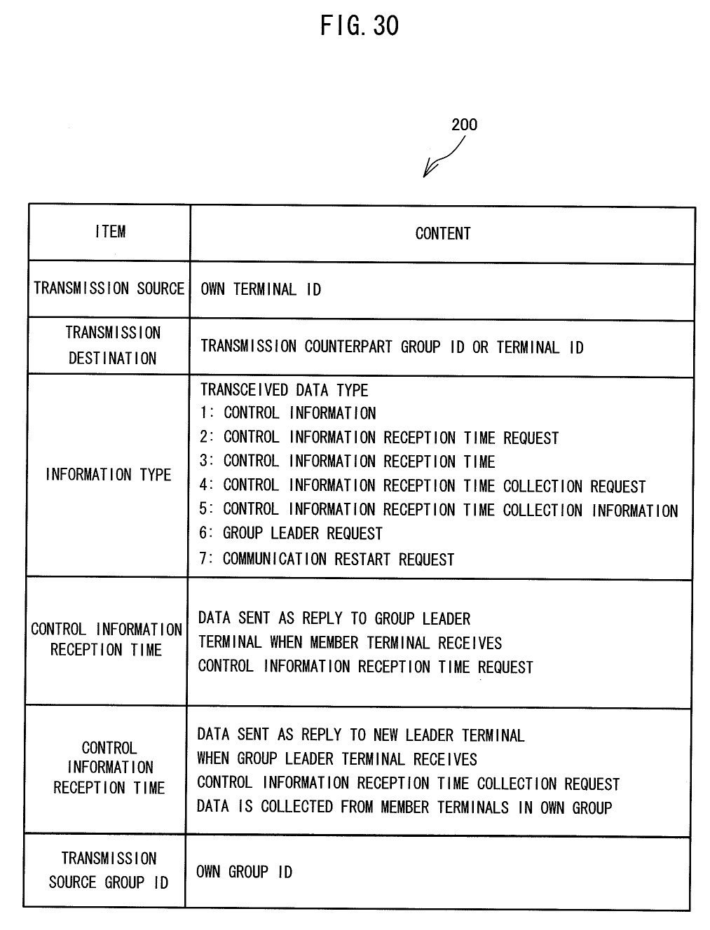

Next, the fourth embodiment will be described with reference to FIG. 30 to FIG. 34. In the fourth embodiment, the group leader terminal 4 is provided in each of the groups in the same manner as in the third embodiment. When the group leader terminal 4 collects the control information reception times, if the control information reception times of all the terminals in the own group are not within a certain period of time, the group leader terminal 4 requests the new leader terminal 3 to restart communication from the own group.

In the wireless communication system 100 of the fourth embodiment, data shown in FIG. 30 is transmitted and received. As shown in FIG. 30, transceived data 200 includes six items, i.e., transmission source information, transmission destination information, information type, control information reception time, control information reception time list, and transmission source group ID. The ID of the terminal that transmits the data is set in the transmission source information. The ID of the group to which the terminal that transmits the data belongs is set in the transmission source group ID. The group ID or the terminal ID of the transmission counterpart is set in the transmission destination information. When the transmission destination information of the received data matches the own terminal ID or the ID of the group to which the terminal itself belongs, the terminal determines that the data is targeted to itself. One of the values 1 to 7 is set in the information type. More specifically, the values are assigned as follows: 1: control information (leader terminal 1→member terminal 2), 2: control information reception time request (group leader terminal 4→member terminal 2), 3: control information reception time (member terminal 2→group leader terminal 4), 4: control information reception time collection request (new leader terminal 3→group leader terminal 4), 5: control information reception time collection information (group leader terminal 4→new leader terminal 3), 6: group leader request (new leader terminal 3→new group leader terminal) and 7: communication restart request (group leader terminal 4→new leader terminal 3). When the information type is 3, data of the control information reception time is set, and when the information type is 5, the control information reception time list is transmitted.

In the fourth embodiment, when the new leader terminal 3 is determined, each of the group leader terminals 4 collects a control information reception time from each of the member terminals 2 in the group. The collected control information reception times are stored in the terminal information storage area 32. If the collected information reception times are not within a certain period of time, the group leader terminal 4 determines that communication is to be restarted from the own group, and transmits the communication restart request to the new leader terminal 3, together with the control information reception time list. The new leader terminal 3 synthesizes the control information reception time lists transmitted from the group leader terminals 4 to form a terminal information table of all the terminals. In addition, if the new leader terminal 3 receives the communication restart request, it determines that communication is to be restarted from that group. If the new leader terminal 3 does not receive the communication restart request, it identifies the communication restart group in the same manner as in the first embodiment.

A main process of the fourth embodiment is similar to the main process (FIG. 25) of the third embodiment. However, a group leader terminal process and a new leader terminal process that are performed in the main process of the fourth embodiment are partially differing. Therefore, descriptions of similar parts are omitted here and only the differences will be described.

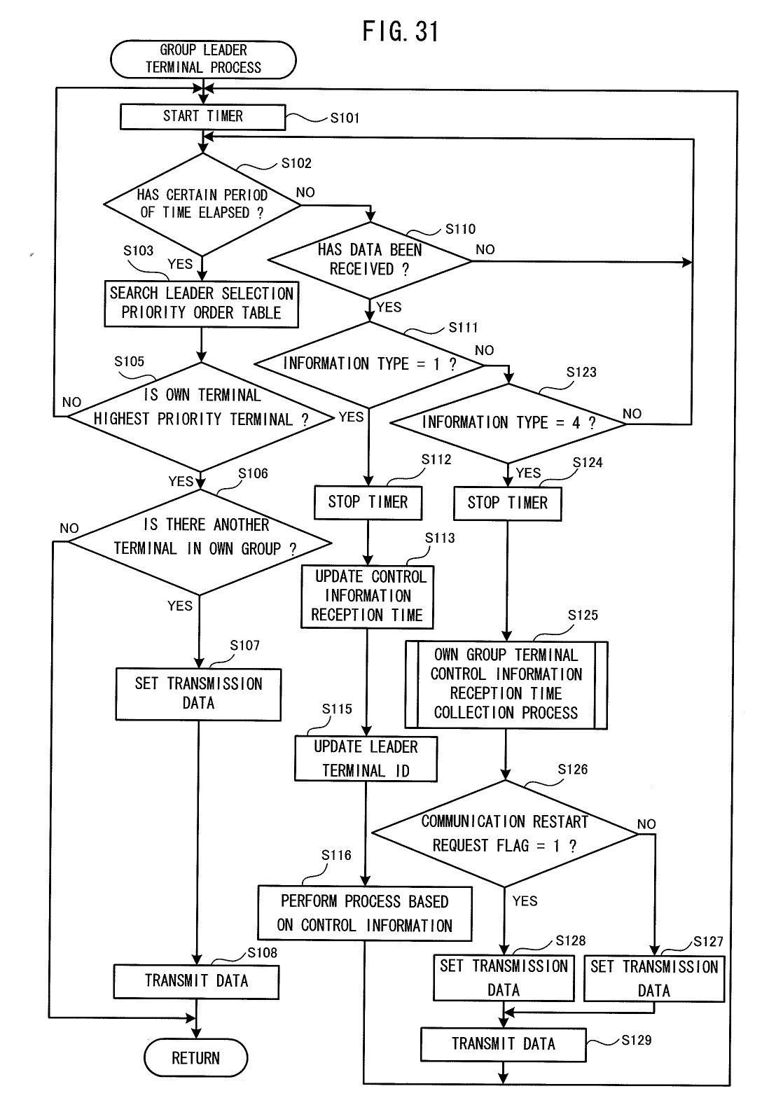

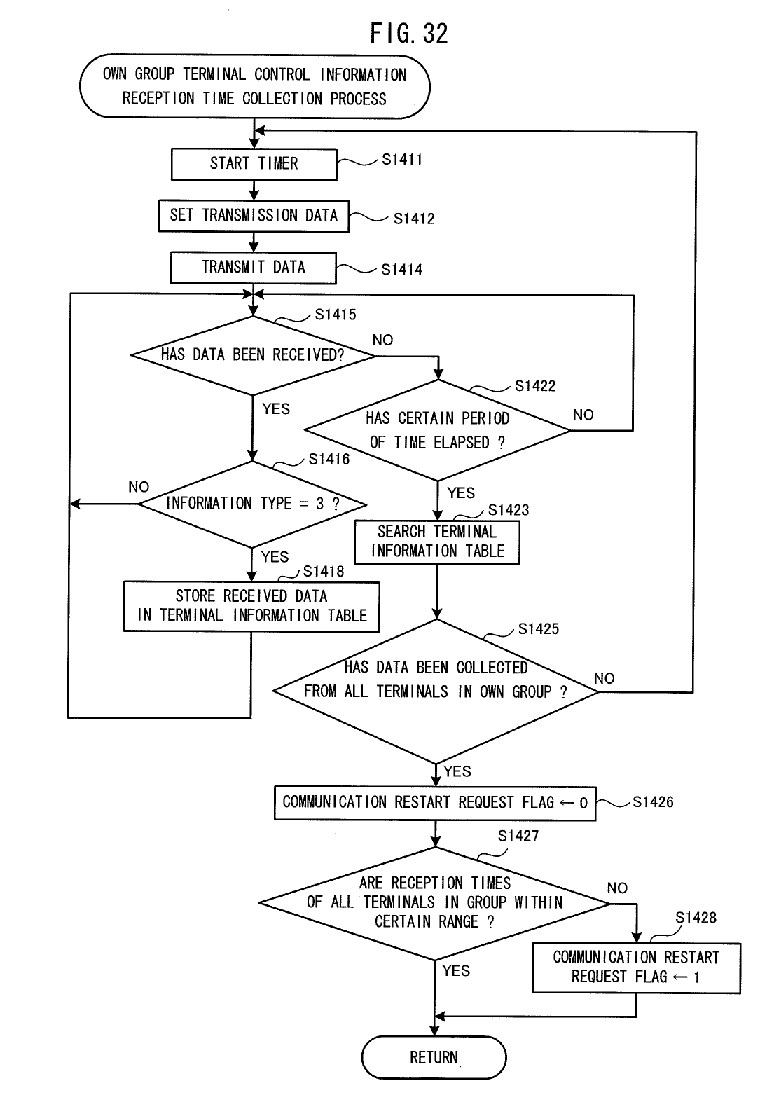

First, the group leader terminal process of the fourth embodiment will be described with reference to FIG. 31 and FIG. 32. The group leader terminal process is performed when the terminal state is “2” (yes at step S90) in the main process shown in FIG. 25. As shown in FIG. 31, when the group leader terminal process is started, first, a timer is started in order to measure the time required to receive the control information from the leader terminal 1 (step S101). Next, it is determined whether a certain period of time has elapsed (step S102). When the certain period of time has elapsed (yes at step S102), there is a failure in communication with the leader terminal 1. Therefore, then, the leader selection priority order table stored in the priority order storage area 31 is searched (step S103).

Next, it is determined, based on the search result at step S103, whether the terminal itself is the highest priority terminal. This can be determined based on whether the own terminal ID is the terminal ID that is next, in the priority order, to the terminal ID of the leader terminal 1 stored in the current leader terminal storage area 35. When the terminal itself is not the highest priority terminal (no at step S105), the process returns to step S101 in order to wait for another priority terminal to complete the processing as the leader terminal 1, and the timer is started again.

When the terminal itself is the highest priority terminal (yes at step S105), thereafter it becomes the new leader terminal 3. As a result, the terminal can no longer function as the group leader terminal 4. Therefore, it is necessary to request another terminal in the own group to function as the group leader terminal 4. First, it is determined whether there is another terminal in the own group (step S106). When there is no other terminal in the own group (no at step S106), the group leader terminal 4 is not necessary for the own group. In this case, the process returns to the main process once in order to perform the processing as the new leader terminal 3.

When there is another terminal in the own group (yes at step S106), transmission data is set to request another terminal in the own group to function as the group leader terminal 4 (step S107). More specifically, the own terminal ID is set in the transmission source, the new group leader terminal ID is set in the transmission destination, and “6” is set in the information type. Then, the set data is transmitted (step S108). After that, the process returns to the main process once in order to perform the processing as the new leader terminal 3. Here, the terminal in the own group that is ranked next, in the priority order, to the terminal itself is selected, by referring to the leader selection priority order table, as the terminal in the own group requested to function as the group leader terminal 4.

When the certain period of time has not elapsed at step S102 (no at step S102), it is determined whether data has been received (step S310). When data has not been received (no at step S110), the process returns to step S102 and it is determined whether the certain period of time has elapsed. When data has been received (yes at step S310), it is determined whether the received information type is “1” (step S111) When the received information type is “1” (yes at step S111), the data is the control information from the leader terminal 1. Therefore, the timer is stopped (step S112), the time at which the control information is received is stored in the reception time storage area 34, and the control information reception time is updated (step S113). Then, the current leader terminal ID is extracted from the transmission source information of the received data, and stored in the current leader terminal storage area 35 (step S115). Then, the process specified by the control information is performed (step S116), and the process returns to step S101 where the timer is started again.

When the information type of the received data is not “1” (no at step S111), next, it is determined whether the information type is “4” (step S123). When the information type is “4” (yes at step S123), the data is a request from the new leader terminal 3 that requests the group leader terminal 4 to collect the control information reception time of each of the member terminals in the group and transmit the result. Therefore, the timer is stopped (step S124), and an own group terminal control information reception time collection process, in which the control information reception time is collected from each of the member terminals 2 in the own group, is performed (step S125).

Here, the own group terminal control information reception time collection process will be described with reference to FIG. 32. When the own group terminal control information reception time collection process is started, first, the timer is started (step S1411). Then, transmission data is set in order to request each member terminal to transmit the reception time (step S1412). More specifically, the own terminal ID is set in the transmission source, the ID of the own group is set in the transmission, destination, and the information type is set to “2”. The information type “2” indicates the request for the control information reception time. Because, the ID of the own group is set in the transmission destination, all the terminals in the own group are targeted.

Next, the set data is transmitted (step S1414), and it is determined whether data has been received (step S1415) When data has been received (yes at step S1415), it is determined whether the information type of the received data is “3” (step S1416). The information type “3” is the data of the control information reception time that the member terminal 2 transmits in response to transmission of the data of the information type “2”. When the information type is “3” (yes at step S1416), the terminal ID, the group ID, and the control information reception time are extracted from the received data, and registered in the terminal information table and stored in the terminal information storage area 32 (step S1418). Then, the process returns to step S1415 to wait for data reception. When the information type is not “3” (no at step S1416), the process returns to step S1415 to wait for data reception again.

When data has not been received (no at step S1415), it is determined whether a certain period of time has elapsed from the timer start at step S1411 (step S1422). When the certain period of time has not elapsed (no at step S1422), the process returns to step S1415 to wait for data reception.

When the certain period of time has elapsed (yes at step S1422), the terminal information table is searched (step S1423), and it is determined whether data has been obtained from all the terminals in the own group (step S1425). When data from all the terminals has not yet been collected (no at step S1425), the process returns to step S1412, and the control information reception time request is made for all the terminals in the own group again.

When data has been collected from all the terminals in the own group (yes at step S1425), then, a communication restart request flag is reset to “0” (step S1426). Next, it is determined whether the control information reception times of all the terminals in the own group are within a certain range (step S1427). Normally, the terminals in the same group have approximately the same reception time. Therefore, if the reception times of the terminals in the group are within the certain range (yes at step S1427), reception has been completed normally in the own group. Therefore, the process directly returns to the group leader terminal process.

When the control information reception times of all the terminals in the own group are not within the certain range (no at step S1427), it is conceivable that a failure has occurred during communication with the own group. Therefore, it is determined that communication is to be first performed with the own group, and the communication restart request flag is set to “1” (step S1428). The communication restart request flag is referred to in the group leader terminal process, and when the flag is “1”, the communication restart request is transmitted from the group leader terminal 4 to the new leader terminal 3. In addition, due to the above-described own group terminal control information reception time collection process, the latest reception time data of all the terminals that are present in the own group and currently communicable are registered in the terminal information table in the terminal information storage area 32.

This completes the own group terminal control information reception time collection process. The process returns to the group leader terminal process shown in FIG. 31. Then, it is determined whether the communication restart request flag is “1” (step S126). When the communication restart request flag is not “1” (no at step S126), the transmission data is set (step S127), which is transmitted with a list attached. The list is a result of collection by the own group terminal control information reception time collection process. More specifically, the own terminal ID is set in the transmission source, the transmission source terminal ID (the terminal ID of the new leader terminal 3) of the data received at step S123 is set in the transmission destination, and the information type is set to “5”. The information type “5” indicates transmission of the control information reception time collection information. Therefore, the control information reception times of the member terminals in the own group are extracted from the terminal information table stored in the terminal information storage area 32 and set. Next, the set data is transmitted (step S129), and the process returns to step S101 where the timer is started again.

When the communication restart request flag is “1” (yes at step S126), the transmission data is set in order to request the new leader terminal 3 to restart communication from the own group (step S128). More specifically, the own terminal ID is Set in the transmission source, the terminal ID of the new leader terminal 3 is set in the transmission destination, and the information type is set to “7”. The information type “7” indicates the communication restart request. Then, the set data is transmitted (step S129), and the process returns to step S101 where the timer is started again.

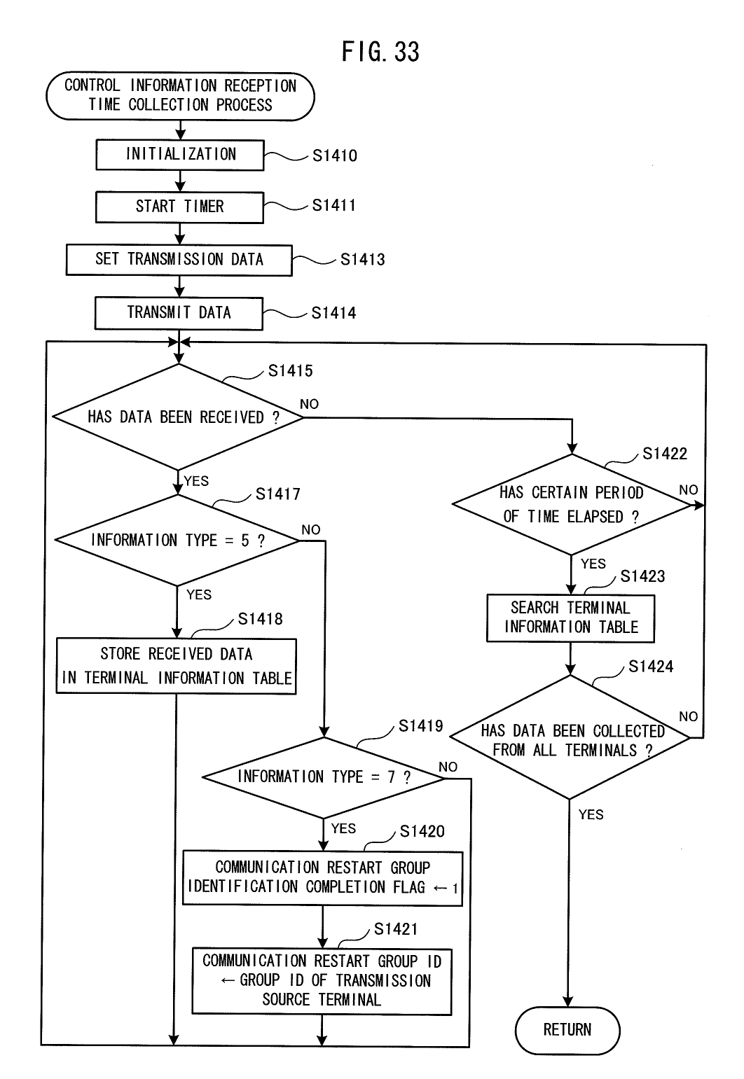

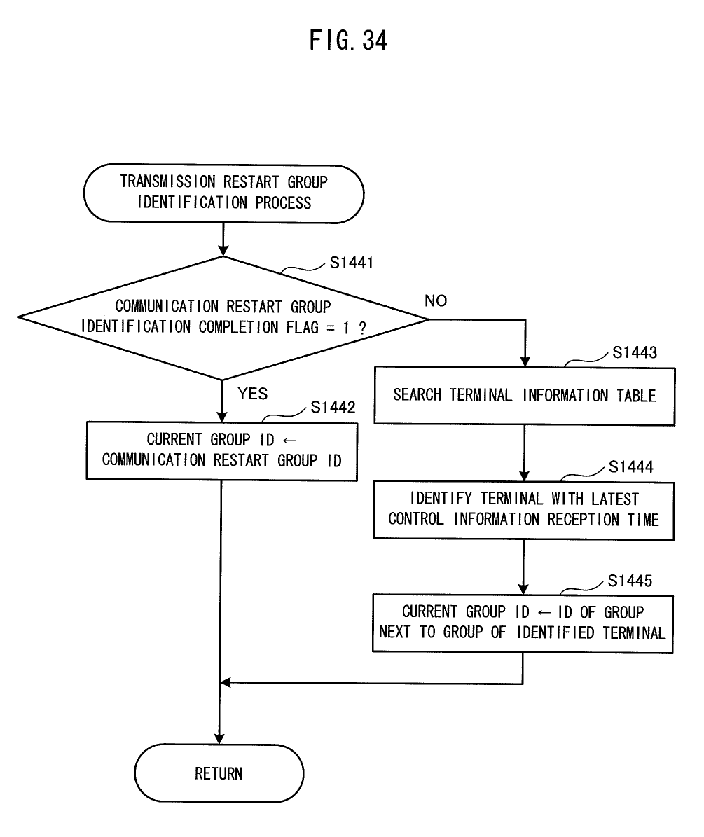

When, in the fourth embodiment, the group leader terminal process is performed in the main process (step S110 of FIG. 25) and as a result, the process proceeds to the new leader terminal process (yes at step S105 of FIG. 27, step S120 of FIG. 25), the new leader terminal process is performed in the same manner as in the first and third embodiments. However, a control information reception time collection process and a communication restart group identification process that are performed in the new leader terminal process are performed in a different manner. These processes will be described in detail with reference to FIG. 33 and FIG. 34.

As shown in FIG. 33, when the control information reception time collection process is started, first, an initialization process is performed (step S1410), that is, the storage area of the RAM 30 is cleared, various set values are reset, and various flags are reset. Next, the timer is started (step S1411). Then, transmission data for requesting each group member terminal to transmit reception time is set (step S1413). More specifically, the own terminal ID is set in the transmission source, the ID of each group leader terminal is set in the transmission destination, and the information type is set to “4”. The information type “4” indicates the request for the control information reception time collection from the member terminals in each group.

Next, the set data is transmitted (step S1414), and it is then determined whether data has been received from each group leader terminal 4 (step S1415). When data has been received (yes at step S1415), it is determined whether the information type of the received data is “5” (step S1416). As described earlier, the information type “5” is the list of the control information reception times of the member terminals in the group, transmitted by the group leader terminal 4 in response to transmission of the data of the information type “4” (refer to step S127 of FIG. 27) When the information type is “5” (yes at step S1417), the terminal ID, the group ID, and the control information reception time are extracted from the received data, and registered in the terminal information table and stored in the terminal information storage area 32 (step S1418).

When the information type is not “5” (no at step S1417), then, it is determined whether the information type is “7” (step S1419). When the information type is not “7” (no at step S1419), the process returns to step S1415 to wait for data reception. When the information type is “7” (yes at step S1419), the group leader terminal 4 has already requested the new leader terminal 3 to restart communication from the own group. Therefore, the new leader terminal 3 does not need to perform the communication restart group identification process at this point in time. Therefore, a communication restart group identification completion flag is set to “1” (step S1420), the group ID of the group leader terminal 4 that has transmitted the data of the information type “7” is set in the communication restart group ID (step S1421), and the process returns to step S1415.

When data has not been received (no at step S1415), it is determined whether a certain period of time has elapsed from the timer start at step S1411 (step S1422). When the certain period of time has not elapsed (no at step S1422), the process returns to step S1415 to wait for data reception.

When the certain period of time has elapsed (yes at step S1422), the terminal information table is searched (step S1423), and it is determined whether data has been obtained from all the terminals (step S1424). When data from all the terminals has been collected (yes at step S1424), the process returns to the new leader terminal process. When data from all the terminals has not yet been collected (no at step S1424), the process returns to step S1415 to wait for data reception.

If the communication restart request is transmitted from one of the group leader terminals 4 by the above-described control information reception time collection process, the group is identified as the communication restart group. Moreover, the latest reception times of the terminals in the group that has not transmitted the communication restart request are registered in the terminal information table of the terminal information storage area 32.

Next, the communication restart group identification process will be described with reference to FIG. 34. First, it is determined whether the communication restart group identification completion flag is “1” (step S1441) The communication restart group identification completion flag is set to “1” when one of the group leader terminals 4 transmits the communication restart request in the control information reception time collection process. Therefore, when the communication restart group identification completion flag is “1” (yes at step S1441), the communication restart group ID is set to the group (current group) ID to be next communicated with. The ID of the group that has transmitted the communication restart request in the control information reception time collection process is set as the communication restart group ID (step S1421 of FIG. 33). Thus, the group that has transmitted the communication restart request is set as the group to be next communicated with.

When the communication restart group identification completion flag is not “1” (no at step S1441), first, the terminal information table in the terminal information storage area 32 is searched (step S1443) in the same manner as in the first embodiment. Then, the terminal that has the latest control information reception time in the terminal information table is identified (step S1444). The group next to the group of the identified terminal is determined as the group to be communicated with (step S1435). Note that, if the reception times of the terminals in the same group are not within a certain range, the communication restart request, not the control information reception time, has already been transmitted by the group leader terminal 4 in the own group terminal control information reception time collection process. Therefore, when the communication restart group identification completion flag is not “1”, such a group does not exist in the terminal information table. Thus, the group next to the group of the identified terminal is determined as the group to be communicated with.

As described above, in the wireless communication system 100 of the fourth embodiment, the group leader terminal 4 is provided in each group in the same manner as in the third embodiment. Each of the group leader terminals 4 requests each of the member terminals 2 in the group to send the control information reception time, and accumulates the obtained information in the terminal information table. When information of all the terminals in the group is collected, each group leader terminal 4 determines whether communication is to be restarted from the own group based on determining whether the control information reception times of the terminals in the group are within a certain range. When the group leader terminal 4 determines that the own group is the communication restart group, it transmits the communication restart request to the new leader terminal 3. When the group leader terminal 4 determines otherwise, it transmits the control information reception time list of the terminals in the group to the new leader terminal 3. Accordingly, if the new leader terminal 3 receives the communication restart request, it can identify the group that has transmitted the communication restart request as the communication restart group. Thus, the communication restart group identification process is shared by the new leader terminal 3 and the group leader terminal 4, and load on the new leader terminal 3 can be reduced.

In the wireless communication system of the present disclosure, each communication terminal belongs to a group, control information is transmitted from a control terminal, and a controlled terminal that receives the control information performs an operation based on the control information. The controlled terminal stores information (communication information) relating to the communication when it receives the control information. Each controlled terminal includes a transition determination device that determines whether the controlled terminal transfers to become the next control terminal. When the transition is determined, the controlled terminal becomes the next control terminal. When the controlled terminal becomes the next control terminal, it identifies the group to which control information is to be transmitted next, based on the communication information stored in each controlled terminal. Accordingly, if some problem occurs and the previous control terminal cannot operate, one of the controlled terminals can function as the new control terminal. Based on the communication information stored in each of the controlled terminals, it is determined up to which group the previous control terminal has completed communication, and communication can be restarted.

In addition, in the wireless communication system of the present disclosure, when control information from the control terminal does not arrive within a predetermined period of time, an order of priority determined in advance is checked in each of the controlled terminals, and the controlled terminal that is the highest in the order of priority becomes the next control terminal. Accordingly, if communication from the control terminal is interrupted by, for example, presence of an obstacle, movement or malfunction of the control terminal, one of the controlled terminals can function as the new control terminal.

In the wireless communication system of the present disclosure, communication information is collected from each of the controlled terminals at the time of transition to becoming the next control terminal, and the group to which control information is to be transmitted next is identified based on the collected results. Therefore, it is determined up to which group the previous control terminal has completed communication by collecting the communication information, and thereby communication can be restarted.

In the wireless communication system of the present disclosure, each of the controlled terminals stores a reception time at which it receives the control information as the communication information. At the time of transition to becoming the next control terminal, the latest reception time of each of the controlled terminals is collected. Then, the controlled terminal that has the latest reception time among the collected reception times is identified. Further, the latest reception time is compared with the reception times of the other controlled terminals in the group to which the identified controlled terminal belongs. Thus, the group or a group next to that group is identified as the next transmission group. In this manner, the reception times are compared by utilizing characteristics of the synchronous communication performed in group units. Thus, communication can be continued promptly if the control terminal is replaced.

In the wireless communication system of the present disclosure, an identifier is assigned when control information is transmitted, and the identifier is stored as communication information. At the time of transition to the next control terminal, the identifier stored in each of the controlled terminals is collected. Accordingly, by determining whether the identifiers stored in the controlled terminals in the same group are the same, the group or a group next to that group is identified as the next transmission group. The group with which communication is to be restarted can be easily identified by assigning the identifier in this manner. Thus, communication can be continued promptly even if the control terminal is replaced.

Moreover, in the wireless communication system of the present disclosure, a group control terminal that controls a group is provided in each group. The group control terminal collects communication information of the controlled terminals in the group. The next control terminal collects from the group control terminal a list of the communication information of all the terminals in the group. Accordingly, even if a large number of the communication terminals are present, the communication information can be effectively collected, and communication can be continued promptly even if the control terminal is replaced.

In the wireless communication system of the present disclosure, the group control terminal collects a reception time as communication information of each of the controlled terminals in the group. Accordingly, even if a large number of the communication terminals are present, the reception time of each of the controlled terminals can be effectively collected through the group control terminal, and the next transmission group can be identified by comparing the reception times in the group and among the groups. Thus, communication can be continued promptly even if the control terminal is replaced.

In the wireless communication system of the present disclosure, the group control terminal collects the identifier, which was assigned and transmitted together with the control information, from each of the controlled terminals in the group. Accordingly, even if a large number of the communication terminals are present, the identifier of each of the controlled terminals can be effectively collected through the group control terminal, and the next transmission group can be identified by comparing the identifiers in the group and among the groups. Thus, communication can be continued promptly even if the control terminal is replaced.

In the wireless communication system of the present disclosure, after the group control terminal has collected the communication information, it determines whether the own group is the next transmission group based on the collected communication information. When it is determined that the own group is the next transmission group, the group control terminal transmits a transmission restart request to the next control terminal. Accordingly, determination load on the next control terminal can be reduced, and even if a large number of the communication terminals are present, communication can be continued promptly.

The communication terminal of the present disclosure functions as a control terminal or as a controlled terminal. When the communication terminal functions as the control terminal, it transmits control information. When the communication terminal functions as the controlled terminal, it stores information (communication information) relating to the communication when receiving the control information, and also performs operations in accordance with the control information. Further, when the communication terminal functions as the controlled terminal, it includes a transition determination device that determines whether the communication terminal transfers to become the next control terminal. When the transition is determined, the communication terminal becomes the next control terminal. In this case, the group to which the control information is to be transmitted next is identified based on the communication information stored in each of the controlled terminals. Accordingly, if some problem occurs and the previous control terminal cannot operate, one of the controlled terminals can function as a new control terminal. Based on the communication information stored in each of the controlled terminals, it is determined up to which group the previous control terminal has completed communication, and communication can be restarted.

According to the communication terminal of the present disclosure, when control information from the control terminal does not arrive within a certain period of time, the priority order determined in advance is checked in each of the controlled terminals, and the controlled terminal that has the highest priority becomes the next control terminal. Accordingly, if communication from the control terminal is interrupted by, for example, presence of an obstacle, movement or malfunction of the control terminal, one of the controlled terminals can function as the new control terminal.

According to the communication terminal of the present disclosure, communication information is collected from each of the controlled terminals at the time of transition to becoming the next control terminal, and the group to which control information is to be transmitted next is identified based on the collected results. Therefore, it is determined up to which group the previous control terminal has completed communication by collecting the communication information, and thereby communication can be restarted.

According to the communication terminal of the present disclosure, the controlled terminal stores the reception time at which it receives the control information as the communication information. At the time of transition to becoming the next control terminal, the latest reception time of each of the controlled terminals is collected. Then, the controlled terminal that has the latest reception time among the collected reception times is identified. Further, the latest reception time is compared with the reception times of the other controlled terminals in the group to which the identified controlled terminal belongs. Thus, the group or a group next to that group is identified as the next transmission group. In this manner, the reception times are compared by utilizing characteristics of the synchronous communication performed in group units. Thus, communication can be continued promptly even if the control terminal is replaced.

According to the communication terminal of the present disclosure, an identifier is assigned when control information is transmitted, and the identifier is stored as communication information. At the time of transition to becoming the next control terminal, the identifier stored in each of the controlled terminals is collected. Accordingly, by determining whether the identifiers stored in the controlled terminals in the same group are the same, the group or a group next to that group is identified as the next transmission group. The group with which communication is to be restarted can be easily identified by assigning the identifier in this manner. Thus, communication can be continued promptly even if the control terminal is replaced.

Moreover, the communication terminal of the present disclosure also functions as a group control terminal that controls each group. The group control terminal collects communication information of the controlled terminals in the group. The next control terminal collects from the group control terminal a list of the communication information of all the terminals in the group. Accordingly, even if a large number of the communication terminals are present, the communication information can be effectively collected, and communication can be continued promptly even if the control terminal is replaced.

When the communication terminal of the present disclosure functions as the group control terminal, it collects the reception time as the communication information of each of the controlled terminals in the group. Accordingly, even if a large number of the communication terminals are present, the reception time of each of the controlled terminals can be effectively collected through the group control terminal, and the next transmission group can be identified by comparing the reception times in the group and among the groups. Thus, communication can be continued promptly even if the control terminal is replaced.

When the communication terminal of the present disclosure functions as the group control terminal, it collects the identifier, which was assigned and transmitted together with the control information, from each of the controlled terminals in the group. Accordingly, even if a large number of the communication terminals are present, the identifier of each of the controlled terminals can be effectively collected through the group control terminal, and the next transmission group can be identified by comparing the identifiers in the group and among the groups. Thus, communication can be continued promptly even if the control terminal is replaced.

When the communication terminal of the present disclosure functions as the group control terminal, after it has collected the communication information, it determines whether the own group is the next transmission group based on the collected communication information. When it is determined that the own group is the next transmission group, the communication terminal functioning as the group control terminal transmits a transmission restart request to the next control terminal. Accordingly, determination load on the next control terminal can be reduced, and even if a large number of the communication terminals are present, communication can be continued promptly.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A wireless communication system in which a control terminal that transmits control information and a plurality of controlled terminals that operate based on the control information transmitted from the control terminal are connected via a wireless communication network, and the control terminal and the controlled terminals belong to one or a plurality of groups, the control information being transmitted in group units, wherein
the control terminal comprises:
a transmission order determination device that determines an order of transmission destination groups to which the control information is transmitted; and
a control information transmission device that transmits the control information to the controlled terminals in the order determined by the transmission order determination device; and wherein
the controlled terminals each comprise:
a control information receiving device that receives the control information from the control terminal;
a communication information storage device that stores communication information that is information relating to the communication when the control information receiving device receives the control information;
a transition determination device that determines whether the controlled terminal becomes a next control terminal that is a control terminal next to a current control terminal; and
a next control terminal transition device that transfers the controlled terminal itself to become the next control terminal when the transition determination device determines that the controlled terminal becomes the next control terminal; and wherein
when the controlled terminal is transferred to become the next control terminal by the next control terminal transition device, the transmission order determination device of the control terminal identifies, from among the groups, a next transmission group to which the control information is to be transmitted next, based on the communication information stored in the communication information storage device of each of the controlled terminals.

2. The wireless communication system according to claim 1, wherein when the control information receiving device does not receive the control information from the control terminal in a predetermined period of time, the transition determination device of the controlled terminal determines whether the controlled terminal becomes the next control terminal in accordance with an order of priority determined in advance.

3. The wireless communication system according to claim 1, wherein
the control terminal includes a communication information collection device that collects the communication information from each of the controlled terminals when the controlled terminal is transferred to become the next control terminal by the next control terminal transition device, and
the transmission order determination device identifies the next transmission group based on the communication information collected by the communication information collection device.

4. The wireless communication system according to claim 3, wherein
each of the controlled terminals stores a reception time at which each of the controlled terminals receives the control information in the communication information storage device as the communication information, and
when the controlled terminal is transferred to become the next control terminal by the next control terminal transition device, the communication information collection device of the control terminal collects the reception time as the communication information, and
the control terminal includes
a latest identification device that identifies a latest group that is a group to which the controlled terminal that has transmitted a latest reception time among all the reception times collected by the communication information collection device belongs, and
a successful reception determination device that determines whether the reception times of all the controlled terminals in the latest group identified by the latest identification device are within a predetermined period of time, and wherein
when the successful reception determination device determines that the reception times are within the predetermined period of time, the transmission order determination device identifies a group next to the latest group in the order determined in advance as the next transmission group, and
when the successful reception determination device determines that the reception times are not within the predetermined period of time, the transmission order determination device identifies the latest group as the next transmission group.

5. The wireless communication system according to claim 3, wherein
the control terminal includes an identifier assignment device that assigns to each transmission destination group an identifier indicating transmission timing of the control information by the control information transmission device,
the control information transmission device transmits the identifier assigned by the identifier assignment device together with the control information,
each of the controlled terminals stores the identifier received from the control terminal as the communication information in the communication information storage device, and
when the controlled terminal is transferred to become the next control terminal by the next control terminal transition device, the communication information collection device of the control terminal collects the identifiers as the communication information, and
the control terminal further includes
a latest identification device that identifies a latest group that has the identifier indicating latest communication, and
an identification determination device that determines whether the identifiers of all the controlled terminals in the latest group identified by the latest identification device are the same, and wherein
when the identification determination device determines that the identifiers are the same, the transmission order determination device identifies a group next to the latest group in the order determined in advance as the next transmission group, and
when the identification determination device determines that the identifiers are not the same, the transmission order determination device identifies the latest group as the next transmission group.

6. The wireless communication system according to claim 3,
wherein
one of the controlled terminals that belong to each of the groups is a group control terminal that controls the group,
the group control terminal includes an inter-group communication information collection device that collects the communication information from the other controlled terminals in the group, and
in the control terminal, the communication information collection device collects from the group control terminal the communication information collected by the inter-group communication information collection device.

7. The wireless communication system according to claim 4, wherein
one of the controlled terminals that belong to each of the groups is a group control terminal that controls the group,
the group control terminal includes an inter-group communication information collection device that collects, from other controlled terminals in the group, the reception time of the control information as the communication information, and
in the control terminal, the communication information collection device collects the reception time collected by the inter-group communication information collection device.

8. The wireless communication system according to claim 5, wherein
one of the controlled terminals that belong to each of the groups is a group control terminal that controls the group,
the group control terminal includes an inter-group communication information collection device that collects the identifier as the communication information from other controlled terminals in the group, and
in the control terminal, the communication information collection device collects the identifier collected by the inter-group communication information collection device.

9. The wireless communication system according claim 6, wherein
one of the controlled terminals that belong to each of the groups is a group control terminal that controls the group, and
the group control terminal includes
a matching determination device that determines whether the own group corresponds to a next transmission group to which the control information is to be transmitted next, based on the communication information collected by the inter-group communication information collection device, and
a transmission device that transmits a transmission restart request to the next control terminal when the matching determination device determines that the own group corresponds to the next transmission group, and that transmits the communication information collected by the inter-group communication information collection device to the next control terminal when the matching determination device determines that the own group does not correspond to the next transmission group, and wherein
when the controlled terminal is transferred to become the next control terminal by the next control terminal transition device and receives the transmission restart request from the transmission device, the transmission order determination device of the control terminal identifies the group that has transmitted the transmission restart request as the next transmission group.

10. A communication terminal that is mutually connected to other communication terminals via a wireless communication network where the communication terminals belong to one or a plurality of groups, the communication terminal functioning either as a control terminal that transmits control information to each of the groups or as a controlled terminal that operates based on the control information transmitted from the control terminal, wherein
when the communication terminal functions as the control terminal, the communication terminal comprises:
a transmission order determination device that determines an order of transmission destination groups to which the control information is transmitted; and
a control information transmission device that transmits the control information to the controlled terminal in the order determined by the transmission order determination device, and
when the communication terminal functions as the controlled terminal, the communication terminal comprises:
a control information receiving device that receives the control information from the control terminal;
a communication information storage device that stores communication information that is information relating to the communication when the control information receiving device receives the control information;
a transition determination device that determines whether the communication terminal becomes a next control terminal that is a control terminal next to a current control terminal; and
a next control terminal transition device that transfers the communication terminal itself to become the next control terminal when the transition determination device determines that the communication terminal becomes the next control terminal, and wherein
when the communication terminal is transferred from being the controlled terminal to becoming the next control terminal by the next control terminal transition device and functions as the control terminal, the transmission order determination device identifies, from among the groups, a next transmission group to which the control information is to be transmitted next, based on the communication information stored in the communication information storage device of each of the controlled terminals.

11. The communication terminal according to claim 10, wherein when the control information receiving device does not receive the control information from the control terminal in a predetermined period of time, the transition determination device determines whether the communication terminal becomes the next control terminal in accordance with an order of priority determined in advance.

12. The communication terminal according to claim 10,
wherein
when the communication terminal is transferred from being the controlled terminal to becoming the next control terminal by the next control terminal transition device and functions as the control terminal, the communication terminal comprises a communication information collection device that collects the communication information from the controlled terminal, and
the transmission order determination device identifies the next transmission group based on the communication information collected by the communication information collection device.

13. The communication terminal according to claim 12, wherein
when the communication terminal functions as the controlled terminal, the communication terminal stores a reception time at which the communication terminal receives the control information in the communication information storage device as the communication information, and
when the communication terminal is transferred from being the controlled terminal to becoming the next control terminal by the next control terminal transition device and functions as the control terminal, the communication information collection device collects the reception time as the communication information, and
the communication terminal further comprises:
a latest identification device that identifies a latest group that is a group to which the controlled terminal that has transmitted a latest reception time among all the reception times collected by the communication information collection device belongs; and
a successful reception determination device that determines whether the reception times of all the controlled terminals in the latest group identified by the latest identification device are within a predetermined period of time; and wherein
when the successful reception determination device determines that the reception times are within the predetermined period of time, the transmission order determination device identifies a group next to the latest group in the order determined by the transmission order determination device as the next transmission group, and
when the successful reception determination device determines that the reception times are not within the predetermined period of time, the transmission order determination device identifies the latest group as the next transmission group.

14. The communication terminal according to claim 12, wherein
when the communication terminal functions as the control terminal, the communication terminal comprises an identifier assignment device that assigns to each transmission destination group an identifier indicating transmission timing of the control information by the control information transmission device, and
the control information transmission device transmits the identifier assigned by the identifier assignment device together with the control information, and
when the communication terminal functions as the controlled terminal, the communication terminal stores the identifier received from the control terminal as the communication information in the communication information storage device, and
when the communication terminal is transferred from being the controlled terminal to becoming the next control terminal by the next control terminal transition device and functions as the control terminal, the communication information collection device collects the identifier as the communication information, and
the communication terminal further comprises;
a latest identification device that identifies a latest group that has the identifier indicating a latest reception timing; and
an identification determination device that determines whether the identifiers of all the controlled terminals in the latest group identified by the latest identification device are the same; and wherein
when the identification determination device determines that the identifiers are the same, the transmission order determination device identifies a group next to the latest group in the order determined by the transmission order determination device as the next transmission group, and
when the identification determination device determines that the identifiers are not the same, the transmission order determination device identifies the latest group as the next transmission group.

15. The communication terminal according to claim 12, wherein
the communication terminal functions as the controlled terminal and also functions as a group control terminal that controls a group to which the communication terminal belongs, and
when the communication terminal functions as the group control terminal, the communication terminal comprises
an inter-group communication information collection device that collects the communication information from other controlled terminals in the group, and
when the communication terminal is transferred from being the controlled terminal to becoming the next control terminal by the next control terminal transition device and functions as the control terminal, the communication information collection device collects from the group control terminal the communication information collected by the inter-group communication information collection device.

16. The communication terminal according to claim 13, wherein
the communication terminal functions as the controlled terminal and also functions as a group control terminal that controls a group to which the communication terminal belongs, and
when the communication terminal functions as the group control terminal, the communication terminal comprises
an inter-group communication information collection device that collects, from other controlled terminals in the group, the reception time of the control information as the communication information, and
when the communication terminal is transferred from being the controlled terminal to becoming the next control terminal by the next control terminal transition device and functions as the control terminal, the communication information collection device collects the reception time collected by the inter-group communication information collection device.

17. The communication terminal according to claim 14, wherein
the communication terminal functions as the controlled terminal and also functions as a group control terminal that controls a group to which the communication terminal belongs, and
when the communication terminal functions as the group control terminal, the communication terminal comprises:
an inter-group communication information collection device that collects, from other controlled terminals in the group, the identifier as the communication information; and
when the communication terminal is transferred from being the controlled terminal to becoming the next control terminal by the next control terminal transition device and functions as the control terminal, the communication information collection device collects the identifier collected by the inter-group communication information collection device.

18. The communication terminal according to claim 15, wherein
when the communication terminal functions as the group control terminal, the communication terminal comprises:
a matching determination device that determines whether the own group corresponds to a next transmission group to which the control information is to be transmitted next, based on the communication information collected by the inter-group communication information collection device; and
a transmission device that transmits a transmission restart request to the next control terminal when the matching determination device determines that the own group corresponds to the next transmission group, and that transmits the communication information collected by the inter-group communication information collection device to the next control terminal when the matching determination device determines that the own group does not correspond to the next transmission group; and wherein
when the communication terminal is transferred from being the controlled terminal to becoming the next control terminal by the next control terminal transition device and functions as the control terminal, if the communication terminal receives the transmission restart request from the transmission device, the transmission order determination device identifies the group that has transmitted the transmission restart request as the next transmission group.

19. A computer-readable storage medium storing wireless communication control program that command a computer to function as various processing devices of the communication terminal that is mutually connected to other communication terminals via a wireless communication network where the communication terminals belong to one or a plurality of groups, the communication terminal functioning either as a control terminal that transmits control information to each of the groups or as a controlled terminal that operates based on the control information transmitted from the control terminal, wherein
when the communication terminal functions as the control terminal, the program comprising:
a transmission order determination step that determines an order of transmission destination groups to which the control information is transmitted; and
a control information transmission step that transmits the control information to the controlled terminal in the order determined at the transmission order determination step, and
when the communication terminal functions as the controlled terminal, the program comprising:
a control information receiving step that receives the control information from the control terminal;
a communication information storage step that stores communication information that is information relating to the communication when the control information is received at the control information receiving step;
a transition determination step that determines whether the communication terminal becomes a next control terminal that is a control terminal next to a current control terminal; and
a next control terminal transition step that transfers the communication terminal itself to become the next control terminal when it is determined that the communication terminal becomes the next control terminal at the transition determination step, and wherein
when the communication terminal is transferred from being the controlled terminal to becoming the next control terminal at the next control terminal transition step and functions as the control terminal, the transmission order determination step identifies, from among the groups, a next transmission group to which the control information is to be transmitted next, based on the communication information stored at the communication information storage step.
